(19) United States
(12) Patent Application Publication
(10) Pub. No.: US 2026/0099608 A1
(43) Pub. Date: Apr. 9, 2026

(54) SECURITY GRAPH CARDINALITY REDUCTION IN NETWORK-BASED COMPUTER SYSTEMS

(71) Applicant: Microsoft Technology Licensing, LLC, Redmond, WA (US)

(72) Inventors: Andrey KARPOVSKY, Kiryat Motzkin (IL); Amir PIROGOVSKY, Tel Aviv (IL); Chen LAHAV, Givatayim (IL); Tamer SALMAN, Haifa (IL); Lital BADASH, Be'er- Sheva (IL)

(21) Appl. No.: 18/905,333

(22) Filed: Oct. 3, 2024

(51) Int. Cl. G06F 21/57

(52) U.S. Cl. CPC G06F 21/577; G06F 2221/034

(57) ABSTRACT

Systems, methods, and techniques are directed to reducing cardinality in graphs of network-based computer systems. In an example, a graph representative of resources in the network-based computer system is generated. The graph comprises nodes representative of resources and edges between nodes representative of relationships between respective nodes. A level of structural similarity between first and second nodes to satisfy a structural similarity criterion. The first and second nodes are grouped in a grouped node, resulting in a modified graph. A security vulnerability of the computer system is identified based on the modified graph. Performance of a mitigation step with respect to the security vulnerability is caused. In another aspect, an edge associated with the first node is grouped in a grouped edge with an edge associated with the second node. In another aspect, a grouped node is grouped with another grouped node as a parent grouped node.

### BACKGROUND

Cloud-based systems are utilized to host computing resources for user accounts. A cloud-based system can have many resources and/or accounts. These have gained the interest of malicious entities, such as hackers. Hackers attempt to gain access to a tenant's computing resources in order to leverage the resources for their own malicious purpose. Security measures are implemented to detect and/or mitigate attacks by malicious entities. In some situations, an asset graph is generated to represent resources of the cloud-based system. This asset graph can have a high cardinality depending on the number of resources and their relationships.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments described herein reduce cardinality in graphs (e.g., security graphs) for network-based computer systems. For example, a graph representative of resources in the network-based computing system is generated. The graph comprises nodes representative of the resources and edges between nodes representing respective attack paths between respective nodes. A level of structural similarity between a first node and a second node of the nodes is determined to satisfy a structural similarity criterion. A modified graph is generated based on the determination that the level of structural similarity satisfies a structural similarity criterion. A security vulnerability of the network-based computing system is identified based on the modified graph. Mitigation of the security vulnerability is caused.

In a further example, the first node and the second node are grouped together in a grouped node, resulting in the modified graph;

In a further example, a first edge associated with the first node and a second edge associated with the second node are grouped as a grouped edge, resulting in the modified graph.

In a further aspect, sparse vectors that semantically represent the first and second nodes are generated. A distance between the sparse vectors is determined in order to determine the level of structural similarity between the first and second nodes. If the distance satisfies a criterion, the level of structural similarity satisfies the structural similarity criterion.

In a further aspect, the structural similarity criterion is modified in order to reduce cardinality of the modified graph.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 shows a block diagram of an example system for generating graphs for network-based computing systems, in accordance with an example embodiment.

FIG. 2 shows a block diagram of an example system comprising the security system of FIG. 1, in accordance with an example embodiment.

FIG. 3 shows a flowchart of a process for reducing cardinality in a graph and mitigating a security vulnerability based on the graph, in accordance with an example embodiment.

FIGS. 4A-4C show examples of a graph at different cardinalities, in accordance with an example embodiment.

FIG. 5 shows a flowchart of a process for grouping edges in a graph, in accordance with an example embodiment.

FIG. 6 shows a flowchart of a process for identifying a security vulnerability based on a graph, in accordance with an example embodiment.

FIG. 7 shows a flowchart of a process for mitigating a security vulnerability with respect to a grouped target, in accordance with an example embodiment.

FIGS. 8A and 8B show examples of a graph with ungrouped and grouped targets, in accordance with an example embodiment.

FIG. 9 shows an example system comprising the structural similarity determiner of FIG. 2, in accordance with an example embodiment.

FIG. 10 shows a flowchart of a process for determining a level of structural similarity satisfies a structural similarity criterion, in accordance with an example embodiment.

FIG. 11 shows a flowchart of a process for determining a distance between sparse vectors, in accordance with an example embodiment.

FIG. 12 shows a flowchart of a process for reducing cardinality in a graph, in accordance with an example embodiment.

FIG. 13 shows a flowchart of a process for adjusting a structural similarity criterion, in accordance with an example embodiment.

FIG. 14 shows a flowchart of a process for presenting a security vulnerability in a user interface, in accordance with an example embodiment.

FIG. 15 shows a flowchart of a process for grouping grouped nodes, in accordance with an example embodiment.

FIGS. 16A-16C show examples of grouping grouped nodes in a graph, in accordance with an example embodiment.

FIG. 17 shows a block diagram of an example computer system in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments of Cardinality Reduction in Graphs

Embodiments of the present disclosure relate to generation of graphs for utilization in detecting security vulnerabilities in network-based computing systems. In particular, graphs are representative of resources of the network-based computing system. Network-based computing systems (e.g., cloud computing network systems, enterprise network systems, etc.) make services and other resources available for users. Depending on the implementation, a network-based computing system makes many resources available to many user accounts. For instance, in a cloud computing network example, services and other resources are made available to entities referred to as “tenants.” Examples of a tenant include, but are not limited to, an individual user, a group of users, an organization with multiple users (e.g., manager users, employee users, guest users, and/or the like), and/or other groupings of users and/or types of users. In some implementations, a tenant is associated with multiple sub-accounts, e.g., user accounts for different users associated with the tenant. The cloud computing network provides the user accounts access to personal resources, shared resources, and/or other resources of the cloud computing network that are associated with a tenant.

Implementations of security systems utilize graphs (e.g., security graphs (also referred to as “asset graphs”)) to evaluate user accounts and resources associated with a tenant (or other type of user). A graph comprises nodes and edges connecting nodes. The nodes represent user accounts and/or resources of the tenant. Examples of resources include, but are not limited to, computing devices of the tenant, applications hosted by the computing network, data stored by the computing network, tokens that enable a user, device, or application to access another application and/or data, and/or other types of resources provided to or hosted on behalf of the tenant by the computing network. Edges of the graph represent relationships between connected nodes. For instance, in some embodiments, an edge represents a node having access to a connected node (e.g., a user account having access to a granted virtual machine), a node granting access to a connected node (e.g., a token granting access to stored data), a node being dependent on another node (e.g., an application hosted by a computing device), and/or another type of relationship between nodes of the graph.

A security system leverages a graph in detecting security vulnerabilities in the computing network, detecting possible attacks ongoing in the computing network, implementing mitigation of vulnerabilities and/or attacks in the computing network, and/or performing other security operations with respect to the tenant account, a user account, and/or resources associated therewith. For instance, in an embodiment, a security system maps a potential attack path in a graph representing an organization's assets that a malicious entity could utilize in accessing sensitive data and/or other secrets of the organization. In another example, security system generates an alert and/or a behavioral signal in the context of the organization's graph. Depending on the complexity of the evaluated network, the resulting graph can have a high cardinality. The cardinality of a graph is representative of the number of nodes in the graph and/or the number of edges in the graph. In some implementations, even a system with a small number of accounts can have a high cardinality, as the number of resources associated with those accounts and the relationships between the resources and/or accounts impact the cardinality of the graph. As the number of accounts and resources increases, the cardinality also increases. For instance, in accordance with an embodiment, a graph has a high cardinality if the number of accounts and/or resources represented in the graph is greater than a predetermined threshold. In an alternative embodiment, a graph has a high cardinality if the number of accounts and/or resources represented in the graph is greater than the number of accounts and/or resources relative to another graph. An increase in cardinality requires more time and compute resources for a security system to evaluate the graph for performing security operations. For instance, a graph of a system that has a high cardinality (e.g., due to the system having a number of accounts and/or resources greater than a predetermined threshold) requires more time and/or compute resources for a security system to evaluate than a graph of a system with a low cardinality (e.g., where the system has a number of accounts and/or resources less than the predetermined threshold). In examples, a graph for a user could have hundreds, thousands, millions, or even greater number of potential attack paths depending on the cardinality of the graph. Furthermore, intermediate steps in a potential attack path can further increase cardinality and/or complexity of the graph.

Embodiments of the present disclosure provide techniques for reducing the cardinality in a graph. For example, in an embodiment, a security system generates a graph representative of resources in a network-based computing system. The graph comprises nodes representative of resources and/or user accounts of the network-based computing system and edges between nodes representing relationships between connected nodes. In an aspect, an edge represents a potential attack path a malicious entity could utilize to access one node from a connected node. The security system determines a level of structural similarity between nodes of the graph that satisfy a structural similarity criterion and groups nodes into respective grouped nodes based on their level of structural similarity, resulting in a modified graph. The security system identifies security vulnerabilities of the network-based computing system based on the modified graph and causes mitigation of the identified vulnerabilities. A security vulnerability is a path or target that poses a risk to a network-based computing system if the path or target were compromised by a malicious entity. In an embodiment, a path or target is considered a security vulnerability if a level of the potential risk the path or target poses to the system is above a predetermined threshold. Examples of a security vulnerability include, but are not limited to, a potential attack path a malicious entity could utilize in order to access resources, a number of resources susceptible to a potential attack path satisfying a vulnerability threshold (e.g., a number of secrets or applications a malicious entity could access utilizing an identified attack path exceeding a predetermined amount), a number of accounts and/or resources able to access a particular secret and/or other sensitive resource satisfying (e.g., exceeding) a predetermined threshold, a number of user accounts that have access to a shared key satisfying a predetermined threshold, a number of attack paths to a sensitive resource satisfying a predetermined threshold, and/or another type of vulnerability in the security of a network-based computing system, as described elsewhere herein. By grouping nodes having a level of structural similarity that satisfies a structural similarity criterion, embodiments of the present disclosure reduce the cardinality of the graph, thereby improving readability of the graph in a user interface and reducing the compute resources utilized to analyze the graph and implement a mitigation of identified vulnerabilities. Furthermore, while the cardinality of the graph is reduced, information regarding nodes of the graph are preserved as a grouped node comprises information related to the nodes grouped therein.

As described above, embodiments described herein identify nodes that have a level of structural similarity satisfying a structural similarity criterion. A level of structural similarity is a degree to which two or more nodes have labels, properties, and/or edges that are identical or semantically similar (e.g., a distance between respective embeddings of labels, properties, and/or edges in vector space satisfies a predetermined threshold). Nodes that have a level of structural similarity satisfying a structural similarity criterion are also referred to as “structurally similar nodes” herein. The level of structural similarity between two nodes is proportionate to (and/or indicative of) the change in structure of the graph if the nodes were swapped with one another in the graph. For instance, if the level of structural similarity between two nodes is higher than a predetermined threshold (e.g., a “structurally similar” threshold), the nodes can be swapped with one another with less change in the structure of the graph than swapping nodes with a level of structural similarity below the predetermined threshold. In an embodiment, two nodes are considered structurally equivalent if they can be swapped with one another in a graph without changing the structure of the graph (e.g., their level of structural similarity is above a structurally identical threshold). In some embodiments, a security system determines the level of structural similarity between two nodes based on a subset of properties and edges. By identifying nodes that have a level of structural similarity that satisfies criterion, security systems described herein are able to group nodes together and reduce cardinality of the resulting modified graph, thereby improving readability of the graph in a user interface and reducing the amount of compute resources consumed in evaluating the graph to identify vulnerabilities and/or mitigation steps.

In some embodiments, a security system reduces cardinality in a graph while preserving information relevant to a particular security feature. In this context, a security feature is a tool or other operation of a security system that evaluates a graph to identify information based on the graph. Examples of security features include, but are not limited to, a feature that identifies attack paths originating from exposed virtual machines or devices, a feature that maps flow of data between nodes, a feature that maps execution of code between nodes, a feature that hunts for security threats and/or anomalies, and/or any other type of tool or other operation that evaluates a particular aspect of resources and/or user accounts of a computing network based on a graph. In some embodiments, a security system determines a level of structural similarity between nodes based on properties, labels, and/or edges that are evaluated by a particular security feature. In this context, the security system is able to reduce cardinality of a graph (e.g., as properties, labels, and/or edges irrelevant to the security feature are ignored or otherwise not utilized in determining the level of structural similarity) while preserving information relevant to the security feature.

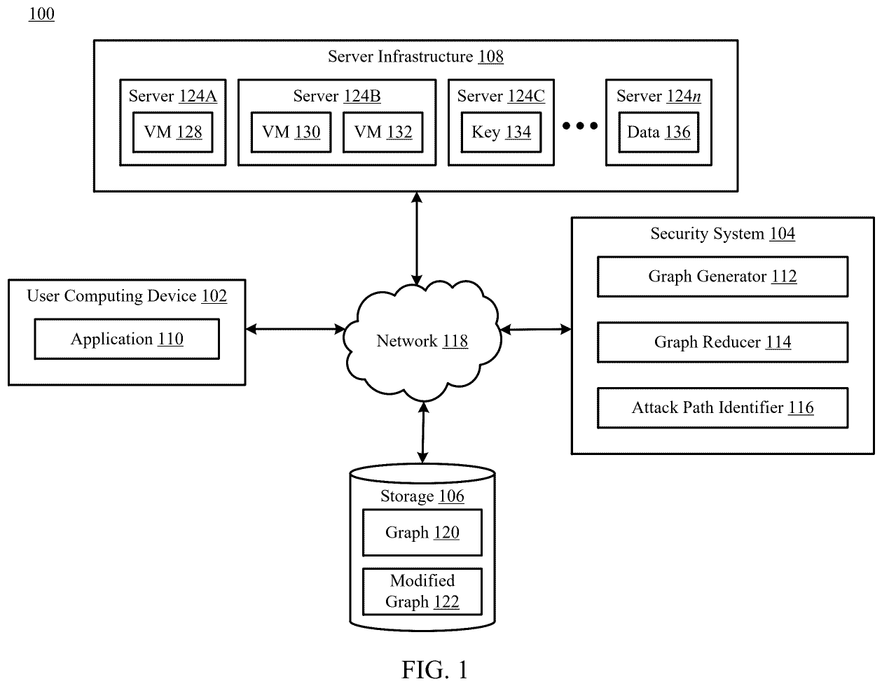

Embodiments are configurable in various ways to reduce cardinality in graphs. FIG. 1 shows a block diagram of an example system 100 for generating graphs for network-based computing systems, in accordance with an example embodiment. As shown in FIG. 1, system 100 comprises a user computing device 102, a security system 104, a storage 106, and a server infrastructure 108, which are communicatively coupled via a network 118. In examples, network 118 comprises one or more networks such as local area networks (LANs), wide area networks (WANs), enterprise networks, the Internet, etc. In examples, network 118 comprises one or more wired and/or wireless portions. The features of system 100 are described in detail as follows.

Server infrastructure 108 is a network-accessible server set (e.g., a cloud-based environment, a cloud-based platform, an enterprise platform, an enterprise environment, and/or the like). As shown in FIG. 1, server infrastructure 108 comprises one or more servers 124A-124n (collectively referred to as “servers 124A-124n”). In some embodiments, two or more of servers 124-124n are grouped together in a cluster. Servers 124A-124n are accessible via network 118. In an embodiment, two or more of servers 124A-124n are co-located (e.g., housed in one or more nearby buildings with associated components such as backup power supplies, redundant data communications, environmental controls, etc.) to form a datacenter. For instance, in a non-limiting example, servers 124A-124n are located in a datacenter in a distributed collection of datacenters. In accordance with another embodiment, one or more of servers 124A-124n are arranged in other manners.

In embodiments, each of servers 124A-124n comprise one or more server computers, server systems, and/or computing devices. In embodiments, any (or all) of servers 124A-124n are configured to host and/or otherwise manage one or more assets (e.g., software applications, services, hardware resources), which are utilized by users (e.g., of user computing device 102) of the network-accessible server set. For example, as shown in FIG. 1, server 124A hosts a virtual machine 128 and server 124B hosts virtual machines 130 and 132. In embodiments, servers execute and/or host other assets, such as, but not limited to, serverless functions, machine learning (ML) workspaces (e.g., a group of compute intensive virtual machines for training ML models and/or performing graphics processing intensive tasks), virtual machine scale sets (e.g., distributed across different servers and/or hosted on the same server), storage disks, web applications, database servers, data objects (e.g., data file(s), table(s), structured data, unstructured data, etc.), a cluster (e.g., a cluster of servers and/or other devices), and/or any other type of hardware, software, and/or network resource associated with a user's computing environment described elsewhere herein. In some embodiments, one or more of servers 124A-124n are configured to store data accessible to other servers, applications executed on the servers, and/or user computing devices over network 118. For example, as shown in FIG. 1, server 124C stores a key 134 and server 124n stores data 136.

User computing device 102 is any type of stationary or mobile processing device, including, but not limited to, a desktop computer, a server, a mobile or handheld device (e.g., a tablet, a personal data assistant (PDA), a smart phone, a laptop, etc.), an Internet-of-Things (IoT) device, etc. In accordance with an embodiment, user computing device 102 is associated with a user (e.g., an individual user, a group of users, an organization, a family user, a customer user, an employee user, a tenant, etc.). In an embodiment, the user of user computing device 102 is a member of a tenant associated with resources of system 100 (e.g., an employee of a tenant organization). In an alternative embodiment, the user of user computing device 102 is a malicious entity (e.g., a hacker) that has infiltrated the tenant organization's resources. User computing device 102 is configured to execute an application 110. In accordance with an embodiment, application 110 enables a user to interface with security system 104, storage 106, and/or server infrastructure 108, e.g., to create assets, to manage assets, to remove assets, to utilize assets, to receive output from security system 104, to manage privileges of a user account of the user, to create user accounts of the tenant, to access storage 106, and/or the like.

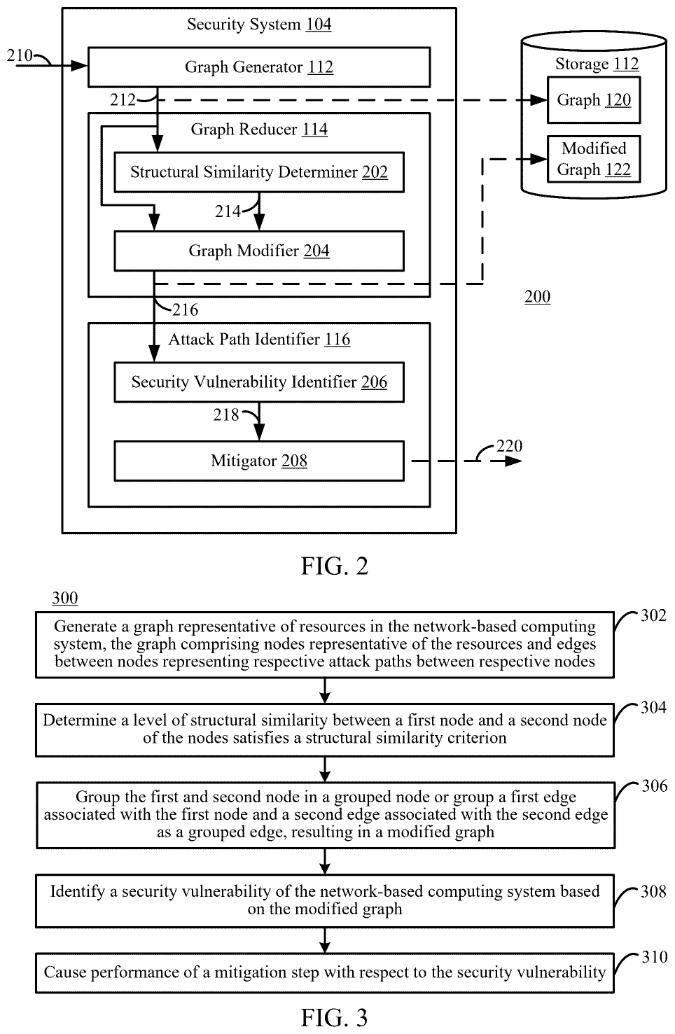

Storage 106 comprises a database, a data store, one or more memory devices and/or the like for storing data. For example, as shown in FIG. 1, storage 106 stores a graph 120 and a modified graph 122. In accordance with an embodiment, graph 120 represents a resources of a network-based computing system (e.g., resources associated with a tenant of the network-based computing system). In an implementation, graph 120 includes nodes representing resources and/or user accounts and edges connecting two or more nodes. In an embodiment, an edge represents a potential attack path or other association between respective nodes. In embodiments, storage 106 stores respective graphs for multiple tenants. Modified graph 122 represents a reduced form of graph 120. For example, in accordance with an embodiment, modified graph 122 represents a version of graph 120 where nodes with a level structural similarity that satisfies a structural similarity criterion are grouped together to form grouped nodes. Additional details regarding graphs and modified graphs are described with respect to FIGS. 2-16, as well as elsewhere herein.

As shown in FIG. 1, storage 106 is separate from user computing device 102, security system 104, and server infrastructure 108. In an alternative embodiment, some or all of storage 106 is implemented in user computing device 102, security system 104, and/or server infrastructure 108. For example, in accordance with an embodiment, storage 106 is integrated in security system 104.

Security system 104 comprises one or more computing devices and is configured to monitor server infrastructure 108 and activity with respect to server infrastructure 108 to detect potential malicious activity. As shown in FIG. 1, security system 104 comprises a graph generator 112, a graph reducer 114, and an attack path identifier 116, each of which are implemented as sub-components of and/or sub-services executed by security system 104. Graph generator 112 is configured to generate a graph (e.g., such as graph 120) representative of resources of a network-based computing system. For example, in accordance with an embodiment, graph generator 112 generates a graph representative of resources of a tenant of a cloud computing network associated with server infrastructure 108. In an embodiment, graph generator 112 generates and/or updates the graph periodically by obtaining a status of and/or properties of resources assigned to the tenant. Alternatively, a telemetry or other monitoring service/device (not shown in FIG. 1) provides updated information to graph generator 112 every time there is activity with respect to the tenant account and/or its resources or on a periodic basis. Example resources include, but are not limited to, resources of server infrastructure 108 assigned to the tenant (e.g., virtual machines 128, 130, and/or 132), data stored by a server infrastructure 108 on behalf of the tenant (e.g., key 134 and/or data 136), a data store or other type of storage that the tenant has access to, applications executed on behalf of the tenant, and/or other resources of a network-based system assigned to the tenant. In accordance with an embodiment, graph generator 112 includes accounts of the tenant account, subscriptions associated with the tenant, and/or users associated with the tenant (e.g., a user account of the user associated with user computing device 102) in the graph. In accordance with an embodiment, graph generator 112 includes devices external to server infrastructure 108 that have access to resources of the tenant, e.g., user computing device 102. In accordance with an embodiment, graph generator 112 stores the graph as graph 120 in storage 106.

Graph reducer 114 is configured to reduce cardinality of graphs generated by graph generator 114. In embodiments, graph reducer 114 identifies nodes of graphs generated by graph generator 114, e.g., graph 120, that have a level of structural similarity that satisfies a structural similarity criterion. In embodiments, graph reducer groups the identified nodes and/or edges associated with the identified nodes, resulting in a modified graph. The modified graph has a cardinality that is lower than the originally generated graph. In some embodiments, graph reducer 114 stores the modified graph in storage 106 as modified graph 122.

Attack path identifier 116 is configured to identify security vulnerabilities based on modified graphs and cause mitigation steps to be performed with respect to identified security vulnerabilities. In accordance with an embodiment, attack path identifier 116 identifies security vulnerabilities based on edges that connect a grouped node of the modified graph to another node or grouped node. In some embodiments, attack path identifier 116 identifies a security vulnerability based on a potential impact related to a grouped node (e.g., a number of nodes within the grouped node that would be impacted by a potential attack). Depending on the implementation, attack path identifier 116 implements an automatic mitigation step to mitigate an identified vulnerability, causes another component of system 100 to implement a mitigation step, and/or causes a notification to be transmitted to a computing device of a user or admin user (e.g., a developer, a security team member, an information technology (IT) team member, and/or the like) to enable the user or admin user to implement a manual mitigation step. In some implementations, the notification comprises a recommended mitigation step and/or a request to approve a mitigation step implemented by security system 104. Example mitigation steps include, but are not limited to, restricting access of a user account and/or a resource, implementing a multi-factor authentication protocol, requesting a user provide a password or other secret (e.g., an answer to a security question, a code sent to their mobile device, and/or the like) to proceed with an operation, isolating a device and/or resource, deactivating or suspending a user account, and/or the like.

Security system 104 of FIG. 1 is configurable in various ways to mitigate security vulnerabilities based on graphs (e.g., security graphs). For example, FIG. 2 shows a block diagram of an example system 200 comprising security system 104, in accordance with an example embodiment. System 200 also comprises storage 106, storing graph 120 and modified graph 122, as described with respect to FIG. 1. As shown in FIG. 2, security system 104 comprises graph generator 112, graph reducer 114, and attack path identifier 116, as described with respect to FIG. 1. As also shown in FIG. 2, graph reducer 114 comprises a structural similarity determiner 202 and a graph modifier 204 and attack path identifier 116 comprises a security vulnerability identifier 206 and a mitigator 208, each of which are incorporated as respective sub-services and/or sub-components thereof. To better understand the operation of security system 104 as shown in FIG. 2, FIG. 2 is described with respect to FIG. 3. FIG. 3 shows a flowchart 300 of a process for reducing cardinality in a graph and mitigating a security vulnerability based on the graph, in accordance with an example embodiment. In an embodiment, security system 104 operates according to the steps of flowchart 300. Note that not all steps of flowchart 300 need be performed in all embodiments. Further structural and operational embodiments will be apparent to persons skilled in the relevant art(s) based on the following descriptions of FIGS. 2 and 3.

Flowchart 300 begins with step 302. In step 302, a graph representative of resources in the network-based computing system is generated, the graph comprising nodes representative of the resources and edges between nodes representing respective attack paths between respective nodes. For example, graph generator 112 of FIG. 2 generates a graph 212 representative of resources in a network-based computing system, e.g. system 100 of FIG. 1. In an embodiment, graph generator 112 generates graph 212 based on activity information 210. Activity information 210 comprises data related to the network-based computing system, the associated account, activity of resources and/or accounts of the computing system, status of data, data flow, code executed, and/or any other information regarding a computing system for which graph generator 112 is generating graph 212. In accordance with an embodiment, graph 212 comprises nodes representative of resources (e.g., virtual machines 128-13, key 134, data 136 of FIG. 1) and edges between nodes representing relationships between respective nodes. In accordance with an embodiment, a relationship between two nodes represents an attack path between the nodes. For instance, as a non-limiting example, an edge between a node representative of virtual machine 128 and a node representative of key 134 represents an attack path from virtual machine 128 to gain access to key 134. In a further example, an edge between the node representative of key 134 and a node representative of data 136 represents an attack path to utilize key 134 to access data 136.

In some embodiments, graph generator 112 stores graph 212, e.g., for later utilization by security system 104, a component of security system 104, and/or another device of the network-based computing system (e.g., application 110 of user computing device 102 of FIG. 1 for display thereof). For instance, as shown in FIG. 2, in some embodiments graph generator 112 stores graph 212 in storage 106 as graph 120.

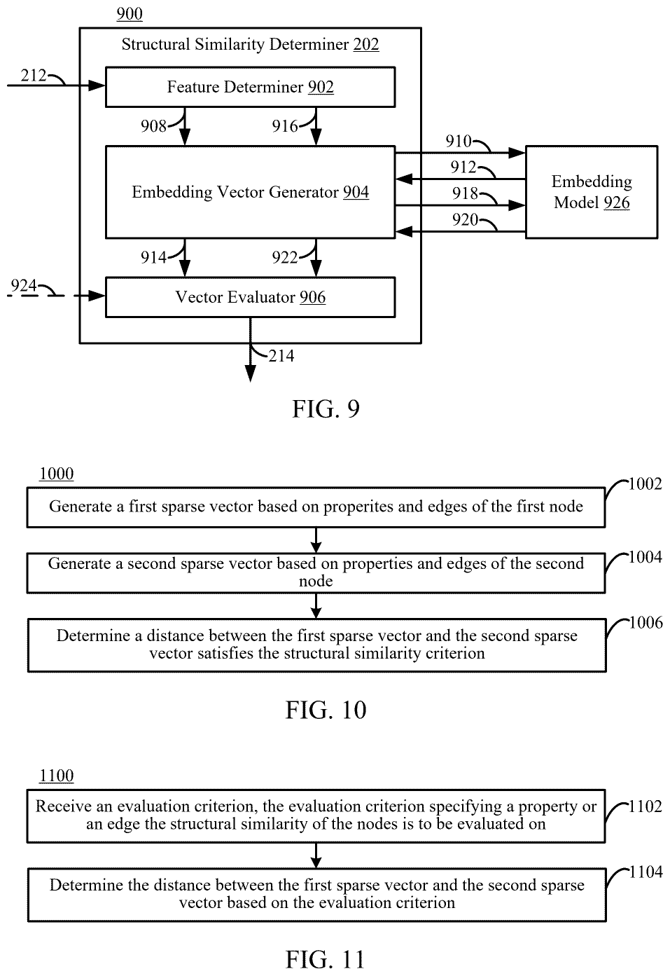

In step 304, a level of structural similarity between a first node and a second node of the nodes is determined to satisfy a structural similarity criterion. For example, structural similarity determiner 202 of FIG. 2 determines a structural similarity between a first node and a second node of the nodes of graph 212. As described herein, structural similarity is a degree to which two or more nodes are similar to one another based on labels, properties, and/or edges. In embodiments, structural similarity determiner 202 determines similarity between the nodes based on particular values of their labels, properties, and/or edges. In some implementations, the similarity is determined by analyzing text or numerical values of the labels, properties, and/or edges and identifying equivalencies between the two nodes. In an alternative embodiment, and as described further with respect to FIGS. 9-11, as well as elsewhere herein, structural similarity determiner 202 determines a level of semantic similarity between two nodes where individual values of properties, labels, and/or edges of the nodes are not necessarily equivalent, but the semantic meaning of the individual values off the properties, labels, and/or edges are equivalent or otherwise satisfy a structural similarity criterion.

In some embodiments, structural similarity determiner 202 determines the level of structural similarity between two or more nodes based on a subset of labels, properties, and/or edges. For instance, in an implementation, structural similarity determiner 202 determines the level of structural similarity between two nodes based on labels, properties, and/or edges that are relevant to a particular security feature of security system 104. Labels, properties, and/or edges are determined to be relevant to a security feature if they are related to aspects evaluated by the security feature. For example, suppose a security feature evaluates attack paths that begin with an exposed virtual machine or computing device. In this context, the security feature evaluates exposure properties, vulnerability properties, and labels of nodes and edges that begin at virtual machines and/or computing devices while not necessarily evaluating other properties, such as properties defining an operating system of a device or virtual machine or an authentication type utilized for the device or virtual machine. In this example, structural similarity determiner 202 determines structural similarity of nodes of graph 212 based on the values of an exposure property, a vulnerability property, and a label of the node as well as whether or not the node is associated with an edge that begins at a computing device or virtual machine. By determining structural similarity based on subsets of properties, labels, and/or edges, embodiments of structural similarity determiner 202 enable further reduction in cardinality of a graph while preserving information that is relevant to a particular security feature.

As shown in FIG. 2, structural similarity determiner 202 provides similarity indication 214 to graph modifier 204. In embodiments, similarity indication 214 comprises an indication of which nodes have a level of structural similarity between them that satisfies the structural similarity criterion, which structural similarity criterion is satisfied (e.g., if there are multiple structural similarity criteria), a (e.g., numerical) representation of the level of structural similarity between the nodes, an indication of edges that have a level of structural similarity between them that satisfies a structural similarity criterion, a representation of the level of structural similarity between edges, and/or any other information regarding structural similarity determined by structural similarity determiner 202.

In step 306, the first and second node are grouped in a grouped node or a first edge associated with the first node and a second edge associated with the second node are grouped in a grouped edge, resulting in a modified graph. For example, graph modifier 204 of FIG. 2 groups nodes and/or edges of graph 212 with a level of similarity that satisfies a structural similarity criterion, as determined by structural similarity determiner 202, resulting in a modified graph 216. For instance, suppose the first node and second node have a level of similarity that satisfies a structural similarity criterion. In this context, subsequent to structural similarity determiner 202 determining the first and second nodes have a level of structural similarity that satisfies the structural similarity criterion, graph modifier 204 groups the nodes together as a grouped node to generate modified graph 216. In an embodiment, the grouped node comprises features of the nodes grouped together by graph modifier 204 (e.g., all features of the first and second nodes). In an alternative embodiment, the grouped node comprises features that are identical between the nodes and/or have a semantic similarity that satisfies a predetermined threshold (e.g., a subset of features of the first and second nodes that are identical, a subset of features of the first and second nodes that have a semantic similarity that satisfies a predetermined threshold, and/or the like). In another embodiment, graph modifier 204 identifies edges of structurally similar nodes. In some embodiments, graph modifier 204 groups the edges as a grouped edge. In implementations, grouping nodes is also referred to as “node contraction” and grouping of edges is also referred to as “edge contraction.” A resulting modified graph is also referred to as a “graph minor” of the original graph. For instance, modified graph 216 is a graph minor of graph 212. In accordance with an embodiment, a grouped node comprises a list of nodes that are included in the grouped node. In accordance with an embodiment, a grouped edge comprises a list of edges (and corresponding connected nodes) that are included in the grouped edge. By including respective lists in this manner, reporting information related to individual nodes and edges is preserved with respect to a modified graph while overall cardinality is reduced.

In some embodiments, graph modifier 204 stores modified graph 216, e.g., for later utilization by security system 104, a component of security system 104, and/or another device of the network-based computing system (e.g., application 110 of user computing device 102 of FIG. 1 for display thereof). For instance, as shown in FIG. 2, in some embodiments graph modifier 204 stores modified graph 216 in storage 106 as modified graph 122.

In step 308, a security vulnerability of the network-based computing system is identified based on the modified graph. For example, security vulnerability identifier 206 of FIG. 2 identifies a security vulnerability of system 100 of FIG. 1 based on modified graph 216. In some embodiments, security vulnerability identifier 206 determines the security vulnerability based on a number of nodes grouped together in a grouped node or a number of edges grouped together in a grouped edge. In some embodiments, security vulnerability identifier 206 determines the vulnerability based on a target of an edge or a vulnerability of an entry point for an attack path. In accordance with an embodiment, security vulnerability identifier 206 identifies an attack path involving the grouped node of the modified graph based on an edge between the grouped node and another node of the modified graph. Furthermore, by identifying a security vulnerability with respect to a grouped node, security vulnerability identifier 206 identifies a potential attack path where a malicious entity is able to laterally attack resources of the computing network. For instance, suppose the grouped node represents different secrets, applications, and/or sensitive data accessible utilizing the same key. In this context, security vulnerability identifier 206 identifies a vulnerability of the secrets, applications, and/or sensitive data to a lateral attack if a malicious entity gains access to the key. As shown in FIG. 2, security vulnerability identifier 206 generates a vulnerability indication 218. In embodiments, vulnerability indication 218 specifies an identified security vulnerability, resources susceptible to the vulnerability, a potential risk of the vulnerability (e.g., loss of data, loss of resources, etc.), and/or any other information associated with the identified vulnerability.

In step 310, a mitigation step is caused to be performed with respect to the security vulnerability. For example, mitigator 208 of FIG. 2 causes a mitigation step to be performed with respect to the security vulnerability identified by security vulnerability identifier 206. In some embodiments mitigator 208 generates a report 220 responsive to vulnerability indication 218. Report 220 comprises information related to the identified security vulnerability (e.g., any information included or otherwise indicated by vulnerability indication 218), a recommended mitigation step to be performed with respect to the identified vulnerability, and/or the like. In some implementations, report 220 includes a visualization of modified graph 216. In some implementations, the visualization comprises a highlight or other indication that identifies the identified security vulnerability and potential attack paths associated therewith.

In some embodiments, mitigator 208 implements a mitigation step automatically. For instance, in accordance with an embodiment, mitigator 208 implements a multi-factor authentication process for accessing secrets and/or applications impacted by the identified vulnerability. In another example, mitigator 208 adds security measures to accounts that pose potential entry for an attack path. In accordance with another example, mitigator 208 divides secrets and/or other secret data that are accessible utilizing a single token in a manner that fewer instances of secrets and/or other secret data are accessible utilizing the same token.

In accordance with an embodiment, the mitigation step comprises implementing a linked alert on connected resources of the grouped node. For instance, suppose the grouped node comprises applications, secrets, and/or sensitive data accessible to another node or through the use of a token of another node. In this context, mitigator 208 implements a linked alert such that unauthorized or anomalous activity with respect to one of the nodes causes an alert to be generated for all nodes of the group. By generating a linked alert in this matter, further mitigation steps can be implemented with respect to other nodes of a grouped node if one of the nodes is compromised, potentially reducing the impact to the entire group.

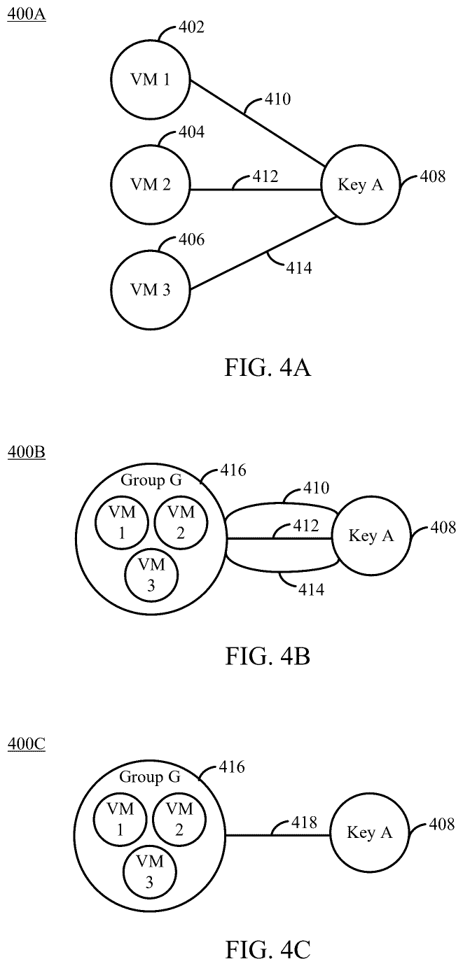

In embodiments, graph 120, modified graph 122, graph 212, and modified graph 216 are representations of user accounts and/or resources of computing networks. In embodiments, such graphs (e.g., security graphs, asset graphs, etc.) can be represented in various ways. For example, FIG. 4A shows an example of a graph 400A generated by graph generator 112 of FIG. 2 (e.g., graph 212). As shown in FIG. 4A, graph 400A comprises nodes 402-408 and edges 410-414. Node 402 represents a Virtual Machine 1, node 404 represents a Virtual Machine 2, node 406 represents a Virtual Machine 3, and node 408 represents a Key A. In accordance with an embodiment, Virtual Machines 1-3 are virtual machines of a tenant of a cloud computing network. In a further aspect, each of Virtual Machines 1-3 have access to Key A. In embodiments, Key A enables a virtual machine to access a secret, sensitive data, and/or the like. To illustrate the relationship between the virtual machines and the key, graph 400A comprises edges that connect nodes 402-406 to node 408. For instance, edge 410 represents a relationship between nodes 402 and 408, edge 412 represents a relationship between nodes 404 and 408, and edge 414 represents a relationship between nodes 406 and 408. In accordance with an embodiment edges 410-414 represent potential attack paths a malicious entity can utilize to access Key A via any of Virtual Machines 1-3. While only nodes 402-408 and edges 410-414 are illustrated in FIG. 4A, it is contemplated herein that a graph can include many nodes and respective relationships between nodes. For instance, in accordance with an embodiment, a graph includes a node representative of data and/or applications that are accessible utilizing Key A. In accordance with another embodiment, a graph includes nodes representative of user accounts associated with any of Virtual Machines 1-3.

As described herein, graph reducer 114 of FIG. 2 operates in a manner intended to reduce cardinality in a graph. For example, suppose structural similarity determiner 202 receives graph 400A of FIG. 4A. In this context, structural similarity determiner 202 evaluates nodes 402-408 (and other nodes of the graph not shown in FIG. 4A for brevity) to determine respective levels of structural similarity between nodes. Depending on the implementation, structural similarity determiner 202 determines the level of structural similarity based on one or more properties of the nodes, a type of the nodes, one or more edges of the nodes, and/or the like. For instance, suppose structural similarity determiner 202 evaluates nodes 402-406 based on the type of node and an edge wherein the edge targets a key. In this context, structural similarity determiner r202 determines that nodes 402-406 share a type (i.e., nodes 402-406 are virtual machines) and have an edge that targets the same key (i.e., edges 410, 412, and 414, respectively). In this example, structural similarity determiner 202 determines that a level of similarity between nodes 402-406 satisfies a structural similarity criterion.

As described herein, embodiments of graph modifier 204 are configured to generate modified graphs by grouping nodes and/or edges based on determined levels of structural similarity. For instance, in accordance with an embodiment, graph modifier 204 groups nodes 402-406 of FIG. 4A into a grouped node, resulting in a modified graph. As an example, FIG. 4B shows an example modified graph 400B having nodes grouped into a grouped node 416. As shown in FIG. 4B, modified graph 400B comprises grouped node 416, node 408, and edges 410-414. Grouped node 416 represents a Group G of nodes 402-406. In accordance with an embodiment, modified graph 400B has a lower cardinality than graph 400A.

In some embodiments, edges that are shared between two nodes can be grouped in order to further reduce the cardinality of a graph. For instance, consider modified graph 400B where edges 410-414 share the same origin, grouped node 416, and the same target, node 408. In this context, graph modifier 204 groups edges 410-414 into a grouped edge. For example, FIG. 4C shows an example modified graph 400C where edges are grouped into a grouped edge. In accordance with an embodiment, modified graph 400C has a lower cardinality than graph 400B.

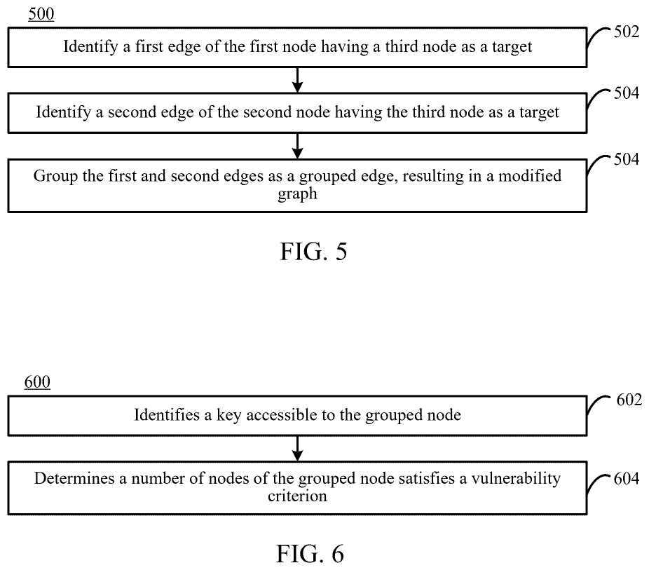

Embodiments of graph reducer 114 operate in various ways to reduce cardinality in a (e.g., security) graph. For example, FIG. 5 shows a flowchart 500 of a process for grouping edges in a graph, in accordance with an example embodiment. In an embodiment, graph reducer 114 of FIG. 2 operates according to the steps of flowchart 500. Note that not all steps of flowchart 500 need be performed in all embodiments. Further structural and operational embodiments will be apparent to persons skilled in the relevant art(s) based on the following description of FIG. 5 with respect to FIGS. 2 and 4A-4C.

Flowchart 500 begins with steps 502 and 504. In accordance with an embodiment, step 502 and/or step 504 are further embodiments of step 304, as described with respect to flowchart 300 of FIG. 3. In step 502, a first edge of the first node is identified, the first edge having a third node as a target. For example, graph modifier 204 of FIG. 2 identifies an edge 410 of FIG. 4A having node 408 as a target. In embodiments, graph modifier 204 identifies edge 410 having node 408 as a target based on a security feature for which the modified graph is being generated for. In some embodiments, graph modifier 204 identifies an edge based on a direction of data flow from one node to another. For example, graph modifier 204 identifies edge 410 with node 408 as a target node based on Key A being a token utilized by Virtual Machine 1 to access a secure resource (e.g., a secure application, a secret, sensitive data, and/or the like).

In step 504, a second edge of the second node is identified, the second edge having the third node as a target. For example, graph modifier 204 of FIG. 2 identifies edge 412 of FIG. 4A having node 408 as a target. In embodiments, graph modifier 204 identifies edge 412 having a target in a similar manner as described with respect to step 502. For example, in an embodiment, graph modifier 204 identifies edge 412 having node 408 as a target node based on Key A being a token utilized by Virtual Machine 2 to access a secure resource.

Flowchart 500 continues to step 506. Step 506 is a further example of step 306 of flowchart 300 of FIG. 3, in an example embodiment. In step 506, the first and second edges are grouped as a grouped edge, resulting in a modified graph. For example, in accordance with an embodiments, graph modifier 204 of FIG. 2 groups edges 410 and 412 as grouped edge 418, resulting in modified graph 400C of FIG. 4C. In accordance with an embodiment, graph modifier 204 groups the edges based on a grouping of or a similarity of source nodes and a grouping of or a similarity of target nodes. For instance, in some embodiments, graph modifier 204 groups edges if the source nodes of the edges satisfy a respective similarity criterion and the target nodes of the edges satisfy a respective similarity criterion. For instance, with respect to the example illustrated in FIG. 4C, since the source nodes of the edges (e.g., nodes 402-406 of FIG. 4A) satisfy a structural similarity criterion and the target node of the edges (e.g., node 408) is the same, graph modifier 204 groups edges 410-414 as grouped edge 418. By grouping edges that share a structurally similar origin and a structurally similar target, embodiments of graph reducer 114 are able to further reduce cardinality of graphs.

Security vulnerability identifier 206 of FIG. 2 operates in various ways to identify security vulnerabilities. For example, FIG. 6 shows a flowchart 600 of a process for identifying a security vulnerability based on a graph, in accordance with an example embodiment. In an embodiment, security vulnerability identifier 206 of FIG. 2 operates according to the steps of flowchart 600. In accordance with an embodiment, flowchart 600 is a further embodiment of step 308 of flowchart 300 of FIG. 3. Note that not all steps of flowchart 600 need be performed in all embodiments. Further structural and operational embodiments will be apparent to persons skilled in the relevant art(s) based on the following description of FIG. 6 with respect to FIGS. 2 and 4C.

Flowchart 600 begins with step 602. In step 602, a key accessible to the grouped node is identified. For example, security vulnerability identifier 206 of FIG. 2 identifies Key A of FIG. 4C as a token accessible to grouped node 416. In an embodiment, security vulnerability identifier 206 identifies Key A based on an edge originating from grouped node 416 and targeting a node representative of Key A (i.e., edge 418).

In step 604, a number of nodes of the grouped node is determined to satisfy a vulnerability criterion. For example, security vulnerability identifier 206 of FIG. 2 determines a number of nodes of grouped node 416 satisfies a vulnerability criterion. In accordance with an embodiment, the vulnerability criterion is set by a tenant of the computing network, is set by a developer of the computing network, and/or is a pre-set default value of security system 104. Depending on the implementation, the vulnerability criterion is proportionate to a potential impact a malicious entity obtaining access to Key A would have on the computing network. For instance, if a malicious entity obtaining Key A would enable the malicious entity to access a single data set, the vulnerability criterion would be less restrictive than if the malicious entity obtaining Key A would enable the malicious entity to access many datasets and/or provide the malicious entity administrative access over portions of (or the entirety of) the computing network.

### III. Example Embodiments of Grouping Target Nodes

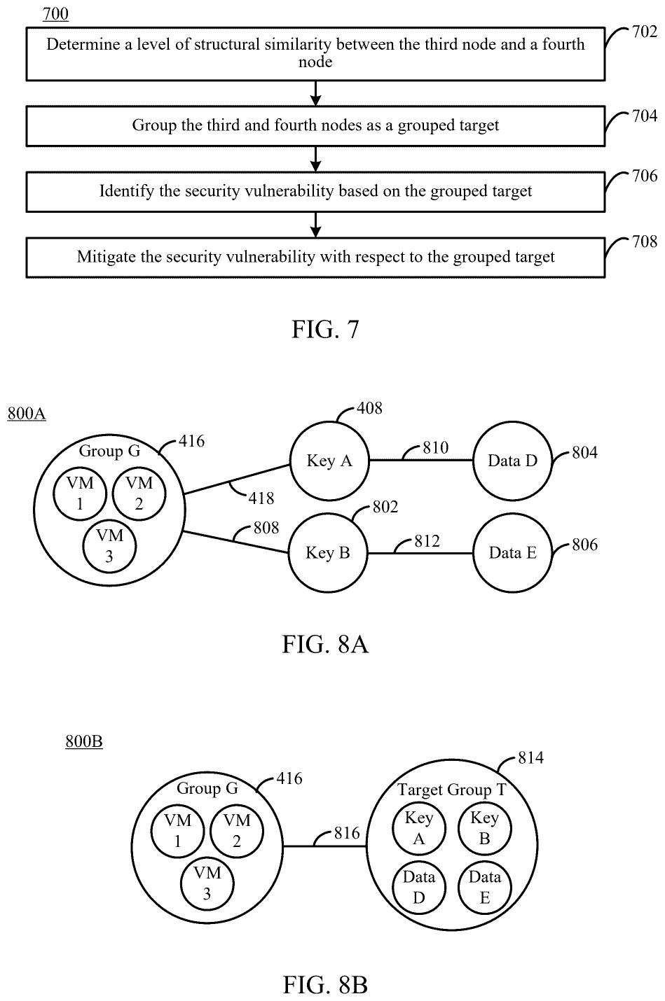

Security system 104 of FIG. 2 operates in various ways to mitigate security vulnerabilities. For instance, in accordance with an embodiment, security system 104 mitigates security vulnerabilities with respect to a grouped target. A grouped target represents a group of two or more nodes that are targeted by edges of a grouped node. Embodiments of security system 104 operate in various ways to identify grouped targets and mitigate security vulnerabilities of grouped targets. For example, FIG. 7 shows a flowchart 700 of a process for mitigating a security vulnerability with respect to a grouped target, in accordance with an example embodiment. In an embodiment, security system 104 of FIG. 2 operates according to the steps of flowchart 700. Note that not all steps of flowchart 700 need be performed in all embodiments. Further structural and operational embodiments will be apparent to persons skilled in the relevant art(s) based on the following description of FIG. 7 with respect to FIG. 2.

Flowchart 700 begins with step 702. In accordance with an embodiment, step 702 is a further embodiment of step 304 and/or a step performed subsequent to step 304 of flowchart 300 of FIG. 3. In step 702, a level of structural similarity between a third node and a fourth node is determined. For example, suppose structural similarity determiner 202 of FIG. 2 determines a level of structural similarity between a third and fourth node of graph 212 satisfies another structural similarity criterion (or, alternatively, the same structural similarity criterion the first and second node satisfied in step 304 of flowchart 300 of FIG. 3).

To better illustrate step 702, step 702 is described with respect to FIG. 8A. FIG. 8A shows an example graph 800A with ungrouped targets in accordance with an embodiment. As shown in FIG. 8A, graph 800A comprises node 408, grouped node 416, and edge 418, as described with respect to FIG. 4C. As also shown in FIG. 8A, graph 800A comprises a node 802 representative of a Key B, a node 804 representative of Data D, a node 806 representative of Data E, an edge 808 connecting grouped node 416 and node 802, an edge 810 connecting node 408 and node 804, and an edge 812 connecting node 802 and node 806. In accordance with an embodiment edge 808 is a grouped edge representing edges connecting nodes representative of Virtual Machine 1, Virtual Machine 2, and Virtual Machine 3 to node 802. In accordance with an embodiment, edge 810 indicates that Data D is accessible utilizing Key A and edge 812 indicates that Data E is accessible utilizing Key B.

In an embodiment, structural similarity determiner 202 of FIG. 2 determines a level of structural similarity of one or more of nodes 408, 802, 804, and 806. For instance, structural similarity determiner 202 in an example determines that nodes 408 and 802 have a level of structural similarity that satisfies a structural similarity criterion based on similar properties and/or edges of the nodes. As a non-limiting example, suppose structural similarity determiner 202 determines nodes 408 and 802 have a level of structural similarity that satisfies a structural similarity criterion based on being targets of an edge originating from grouped node 416. In a further example, structural similarity determiner 202 determines nodes 804 and 806 have a level of structural similarity that satisfies a structural similarity criterion based on being ultimate targets of attack paths originating from grouped node 416. In an even further example, structural similarity determiner 202 determines nodes 408, 802, 804, and 806 have a level of structural similarity that satisfies a structural similarity criterion that specifies nodes that are targets of an attack originating from a virtual machine or computing device and intermediary nodes are structurally similar.

Flowchart 700 continues to step 704. In accordance with an embodiment, step 704 is a further embodiment and/or a subsequent step to step 306 of flowchart 300 of FIG. 3. In step 704, the third and fourth nodes are grouped as a grouped target. For example, graph modifier 204 of FIG. 2 groups the third and fourth nodes as a grouped target. To better illustrate step 704, step 704 is described with respect to FIG. 8B. FIG. 8B shows an example of a graph 800B where targets having a level of structural similarity that satisfies a structural similarity criterion are grouped together, in accordance with an example embodiment. As shown in FIG. 8B, graph 800B comprises grouped node 416, as described with respect to FIG. 4C, a grouped target node 814, and an edge 816. In accordance with an embodiment, graph modifier 204 of FIG. 2 groups nodes 408, 802, 804, and 806 of graph 800A of FIG. 8A into grouped target node 814, also referred to as Target Group T. Edge 816 represents a relationship between grouped node 416 and grouped target node 814. In accordance with an embodiment, graph modifier 204 of FIG. 2 generates edge 816 by grouping edges 418 and 808 of graph 800A of FIG. 8A into edge 816. In an embodiment, grouped target node 814 represents potential targets that would be exposed to a node of grouped node 416 if that node was compromised.

Flowchart 700 continues to step 706. In accordance with an embodiment, step 706 is a further embodiment of step 308 of flowchart 300 of FIG. 3. In step 706, the security vulnerability is identified based on the grouped target. For example, security vulnerability identifier 206 identifies a security vulnerability of the computing network based on grouped target node 814. In embodiments, security vulnerability identifier 206 identifies the security vulnerability in various ways. For instance, in accordance with an embodiment, security vulnerability identifier 206 determines the security vulnerability based on a quantity and/or type of secrets that would be exposed to a compromised virtual machine and/or computing device satisfying a risk criterion. In an embodiment, security vulnerability identifier 206 includes the security vulnerability and information regarding target node 814 in vulnerability indication 218.

Flowchart 700 continues to step 708. In accordance with an embodiment, step 708 is a further embodiment of step 310 of flowchart 300 of FIG. 3. In step 708, the security vulnerability is mitigated with respect to the grouped target. For example, mitigator 208 of FIG. 2 mitigates the identified security vulnerability indicated in vulnerability indication 218 with respect to grouped target node 814. In an embodiment, mitigator 208 implements a mitigation step by linking an alert with the targets of grouped target node 814 such that unauthorized or otherwise anomalous access to one of the nodes of grouped target node 814 causes an alert to be generated for another node of grouped target node 814 (e.g., all nodes of grouped target node 814). In another embodiment, mitigator 208 implements a mitigation step by implementing different access policies for different nodes or subgroups of nodes of grouped target node 814. By implementing separate access policies, mitigator 208 reduces a node's ability to access the same target nodes in the same manner.

### IV. Example Embodiments of Cardinality Reduction Utilizing Embedding Vectors

Structural similarity determiner 202 of FIG. 2 is configurable in various ways to determine a level of structural similarity between nodes of a graph, in embodiments. In some embodiments, structural similarity determiner 202 determines a level of structural similarity between nodes based on embeddings of the nodes. In embodiments, embeddings are represented as vectors of floating-point numbers such that the distance between two embeddings in vector space is correlated with semantic similarity between two inputs in their original format. In an implementation, structural similarity determiner 202 determines embeddings for a node based on values of labels, properties, and/or edges of the node. Alternatively, structural similarity determiner 202 utilizes an embedding model configured to generate embeddings that semantically represent input. Embodiments of structural similarity determiner 202 are configured to determine a level of structural similarity based on embeddings in various ways. For example, FIG. 9 shows an example system 900 comprising structural similarity determiner 202 of FIG. 2, in accordance with an example embodiment. As shown in FIG. 9, system 900 also comprises an embedding model 926. In accordance with an embodiment, embedding model 926 is configured to generate embeddings that semantically represent received input. As also shown in FIG. 9, structural similarity determiner 202 comprises a feature determiner 902, an embedding vector generator 904, and a vector evaluator 906, each of which are implemented as subcomponents and/or sub-services of structural similarity determiner 202.

To better understand the operation of system 900, FIG. 9 is described with respect to FIG. 10. FIG. 10 shows a flowchart of a process for determining a level of structural similarity satisfies a structural similarity criterion, in accordance with an example embodiment. In an embodiment, structural similarity determiner 202 of FIG. 9 operates according to the steps of flowchart 1000. Note that not all steps of flowchart 1000 need be performed in all embodiments. In accordance with an embodiment, flowchart 1000 is a further example of step 308 of flowchart 300 of FIG. 3. Further structural and operational embodiments will be apparent to persons skilled in the relevant art(s) based on the following description of FIGS. 9 and 10.

Flowchart 1000 begins with step 1002. In step 1002, a first sparse vector is generated based on properties and edges of the first node. For example, embedding vector generator 904 of FIG. 9 generates a first sparse vector 914 (also referred to as “vector 914” herein) based on properties and edges of a first node. In accordance with an embodiment, properties and edges are collectively referred to as “node features” herein. In an embodiment, feature determiner 902 determines the node features of a node based on graph 212. For instance, feature determiner 902 determines node features 908 of the first node based on graph 212. In an embodiment, embedding vector generator 904 determines an embedding space S′ that nodes are to be represented in. In a non-limiting example, embedding space S′ is represented as follows:

$${S}^{′} = [ label 1 , label 2 , label 3 , property 1 , property 2 , property 3 , edge 1 , edge 2 , edge 3 ]$$

Nodes in graph 212 can be represented as sparse vectors in space S′. For example, a node nᵢ can be represented by the following sparse vector:

$$s\_i = [ 0 , 1 , 0 , 1 , 1 , 0 , 1 , 0 , 0 ]$$

where s_i is a vector in space S′. Embedding vector generator 904 generates vector 914 for the first node in embedding space S′. In accordance with an embodiment, and as shown in FIG. 9, embedding vector generator 904 provides an input 910 to embedding model 926 to cause embedding model 926 to generate vector 914. In an embodiment, input 910 specifies embedding space S′ and node features 908. Embedding model 926 determines embeddings representative of the semantic meaning of the first node based on embedding space S′ and node features 908. As shown in FIG. 9, embedding model 926 provides an output 912 to embedding vector 904. In accordance with an embodiment, output 912 comprises vector 914.

In step 1004, a second sparse vector is generated based on features and edges of the second node. For example, embedding vector generator 904 of FIG. 9 generates a second sparse vector 922 (also referred to as “vector 922” herein) in a similar manner as vector 914. For instance, feature determiner 902 determines node features 916 for the second node and embedding vector generator 904 provides node features 916 and embedding space S′ as input 918 to embedding model 926. Embedding model 926 generates vector 922 based on node features 916 and embedding space S′. As shown in FIG. 9, embedding model 926 provides an output 920 to embedding vector generator 904. In embodiments, output 920 comprises vector 922.

In step 1006, a distance between the first sparse vector and the second sparse vector is determined to satisfy the structural similarity criterion. For example, vector evaluator 906 of FIG. 9 determines a distance between vectors 914 and 922 satisfies a structural similarity criterion. In embodiments, vector evaluator 906 measures the distance between vectors 914 and 922 in embedding space S′ to determine the distance. In some embodiments, vector evaluator 906 measures the distance based on all values within the vectors. Alternatively, and as further described with respect to FIG. 11 as well as elsewhere herein, vector evaluator 906 measures the distance based on a subset of values within the vectors.

As described with respect to FIGS. 9 and 10, vector evaluator 906 of FIG. 9 determines the distance between vectors. In some embodiments, vector evaluator 906 determines distance between vectors based on (e.g., only) a subset of labels, properties, edges and/or other features of nodes. Vector evaluator 906 operates in various ways to determine distance between vectors based on a subset of features, in embodiments. FIG. 11 shows a flowchart 1100 of a process for determining a distance between sparse vectors, in accordance with an example embodiment. In an embodiment, vector evaluator 906 of FIG. 9 operates according to the steps of flowchart 1100. Note that not all steps of flowchart 1100 need be performed in all embodiments. Further structural and operational embodiments will be apparent to persons skilled in the relevant art(s) based on the following description of FIG. 11 with respect to FIG. 9.

Flowchart 1100 begins with step 1102. In step 1102, an evaluation criterion is received, the evaluation criterion specifying a property or an edge the structural similarity of the nodes is to be evaluated on. For example, vector evaluator 906 of FIG. 9 receives evaluation criterion 924. Evaluation criterion 916 specifies a property or edge the structural similarity of vectors 914 and 922 is to be evaluated on. As a non-limiting example, suppose evaluation criterion 924 specifies an edge “e_k” that nodes are to be evaluated on, where edge e_k specifies an access to a particular token or to a token of a particular group of tokens.

In step 1104, the distance between the first and second sparse vectors is determined based on the evaluation criterion. For example, vector evaluator 906 determines a distance between vector 914 and vector 922 based on evaluation criterion 924. For instance, considering the non-limiting example described with respect to step 1102 where evaluation criterion 924 specifies edge e_k. In this context, vector evaluator 906 determines a distance between vectors 914 and 922 based at least on their value for an embedding corresponding to edge e_k, without necessarily having the same other edges or properties. This enables graph reducer 204 to reduce cardinality of the graph while preserving information relevant to the evaluation criteria.

Embodiments of structural similarity determiner 202 have been described with respect to flowchart 1100 of FIG. 11 wherein vector evaluator 906 receives evaluation criterion 924. However, embodiments described herein are not so limited. For instance, in accordance with an alternative embodiment, embedding vector generator 904 receives evaluation criterion 924. In this context, embedding vector generator 904 generates embedding space S′ based on evaluation criterion 924. By generating embedding space S′ in this manner, fewer compute resources are utilized to determine the space. Furthermore, fewer compute resources are expended by embedding model 926 in generating vectors as the size of the vectors are limited by embedding space S′. In another alternative embodiment, feature determiner 902 receives evaluation criterion 924 and determines node features of nodes based on evaluation criterion 924. By determining node features in this manner, fewer compute resources are expended in determining features, as only a subset of features are determined.

### V. Example Embodiments of Iterative Cardinality Reduction

As described herein, graph reducer 114 reduces the cardinality of graphs. Furthermore, depending on the implementation (e.g., as described with respect to flowchart 1100 of FIG. 11), graph reducer 114 reduces cardinality based on evaluation criterion. In some situations, the resulting modified graph has an unsatisfactory cardinality. For instance, suppose graph reducer 114 reduces a graph to a modified graph, however, the number of grouped nodes, ungrouped nodes, grouped edges, and ungrouped edges is still numerous. For instance, a resulting modified graph reviewed by an admin user in one implementation is difficult to visually evaluate in order to determine potential vulnerabilities and possible solutions to those vulnerabilities. In another implementation, the complexity of the resulting modified graph (e.g., the number of grouped nodes, ungrouped nodes, grouped edges, ungrouped edges, and/or the like) is at a level that requires attack path identifier 116 of FIG. 1 to expend a great number of compute resources and/or time to identify potential security vulnerabilities, determine mitigation steps to perform with respect to identified vulnerabilities, and/or implement mitigation steps. In accordance with an embodiment, graph reducer 114 operates in an iterative manner to reduce cardinality in a graph to further reduce complexity of a resulting modified graph.

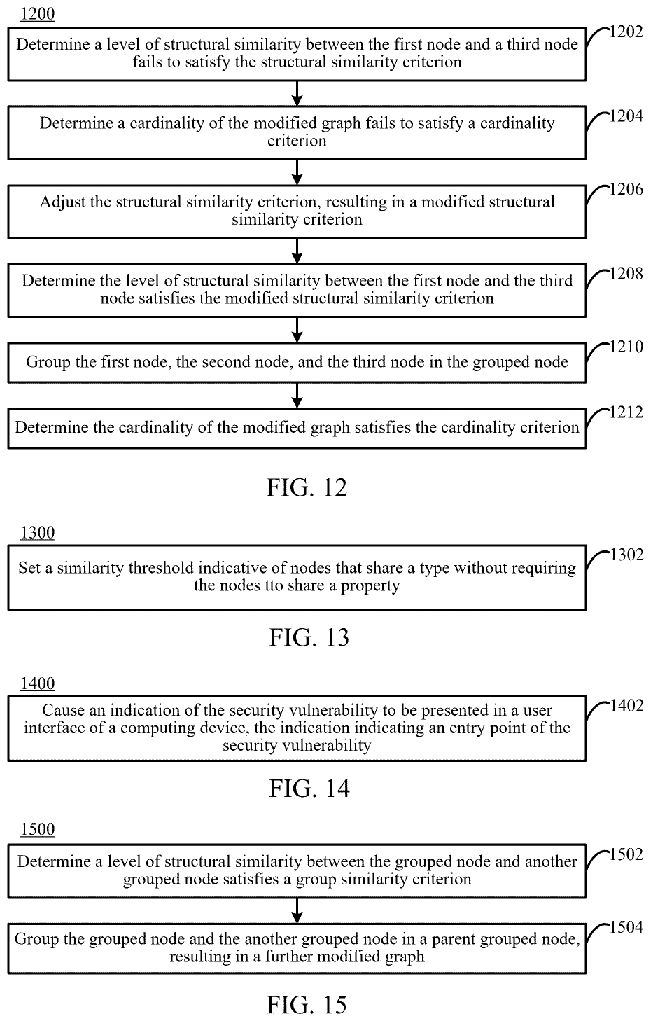

Graph reducer 114 operates in various manners to iteratively reduce cardinality of a graph. For example, FIG. 12 shows a flowchart 1200 of a process for reducing cardinality in a graph, in accordance with an example embodiment. In an embodiment, graph reducer 114 of FIG. 2 operates according to the steps of flowchart 1200. Note that not all steps of flowchart 1200 need be performed in all embodiments. In some embodiments, one or more steps of flowchart 1200 are further embodiments of step 304 and/or step 306 of flowchart 300 of FIG. 3. Further structural and operational embodiments will be apparent to persons skilled in the relevant art(s) based on the following description of FIG. 12 with respect to FIGS. 2, 4A, and 4B.

Flowchart 1200 begins with step 1202. In step 1202, a level of structural similarity between the first node and a third node is determined to fail to satisfy the structural similarity criterion. For example, structural similarity determiner 202 determines a level of structural similarity between a first node and a third node fails to satisfy a structural similarity criterion. As an illustrative non-limiting example, consider graph 400A of FIG. 4B. Suppose in this non-limiting example that structural similarity determiner 202 determines a level of structural similarity between nodes 402 and 404 satisfy a structural similarity criterion but the level of structural similarity between nodes 402 and 406 fails to satisfy the structural similarity criterion. In this context, graph modifier 204 groups nodes 402 and 404 as a grouped node without grouping node 406 in the grouped node.

In step 1204, a cardinality of the modified graph is determined to fail to satisfy a cardinality criterion. For example, graph modifier 204 or another component of graph reducer 114 evaluates the modified graph comprising nodes 402 and 404 as a grouped node and determines a cardinality of the modified graph fails to satisfy a cardinality criterion. In accordance with an embodiment, the cardinality criterion specifies a maximum number of elements (e.g., a maximum number of nodes, a maximum number of edges, or a maximum number of nodes and edges) the modified graph is to have. In this context, the cardinality criterion is a minimum threshold of similarity utilized to define structurally similar nodes. In an implementation, a higher threshold causes graph reducer 114 to generate a high-level visualization of a graph with a lower level of cardinality while a lower threshold causes graph reducer 114 to generate a low-level visualization of the graph with a higher level of cardinality. In an embodiment, a default or initial cardinality criterion is predetermined for security system 104. Alternatively, the cardinality criterion is configurable by a developer or user of the computing network.

In step 1206, the structural similarity criterion is adjusted, resulting in a modified structural similarity criterion. For example, structural similarity determiner 202 of FIG. 2 adjusts the structural similarity criterion, resulting in a modified structural similarity criterion. Structural similarity criterion are configurable in various ways. For instance, suppose the structural similarity criterion specifies grouping nodes together that share a property, a node type, and an edge. Further suppose the resulting modified graph has a cardinality that exceeds the cardinality criterion as determined in step 1204. In this context, structural similarity determiner 202 adjusts the structural similarity criterion to specify grouping nodes together that have similar values for a property and share the same node type and share the same edge. In another example, structural similarity determiner 202 adjusts the structural similarity criterion to specify grouping nodes together that have the same node type and have the same edge, but do not necessarily share other properties.

In step 1208, the level of structural similarity between the first and third nodes is determined to satisfy the modified structural similarity criterion. For example, structural similarity determiner 202 of FIG. 2 determines the level of structural similarity between the first and third nodes satisfies the modified structural similarity criterion. For instance, returning to the non-limiting example described with respect to step 1202 and graph 400A of FIG. 4A, suppose structural similarity determiner 202 determines the level of structural similarity between nodes 402, 404, and 406 satisfies the modified structural similarity criterion.

In step 1210, the first, second, and third nodes are grouped in the grouped node. For example, graph modifier 204 of FIG. 2 groups the first, second, and third nodes into a grouped node. For instance, with continued reference to the non-limiting example described with respect to steps 1202 and 1208, suppose graph modifier 204 groups nodes 402-406 of FIG. 4A into grouped node 416 of FIG. 4B.

In step 1212, the cardinality of the modified graph is determined to satisfy the cardinality criterion. For instance, graph modifier 204, or another component of graph reducer 114, determines the cardinality of modified graph 216 satisfies the cardinality criterion. In this context, graph modifier 204 provides modified graph 216 to attack path identifier 116 for identification of security vulnerabilities and mitigation of vulnerabilities, as described elsewhere herein.

As described with respect to step 1206 of flowchart 1200 of FIG. 12, graph reducer 114, in some embodiments, adjusts structural similarity criterion. Graph reducer 114 operates in various ways to adjust structural similarity criterion. For example, FIG. 13 shows a flowchart 1300 of a process for adjusting a structural similarity criterion, in accordance with an example embodiment. In an embodiment, graph reducer 114 of FIG. 2 operates according to the steps of flowchart 1300. Note that flowchart 1300 need not be performed in all embodiments. Further structural and operational embodiments will be apparent to persons skilled in the relevant art(s) based on the following description of FIG. 13 with respect to FIGS. 2 and 4A.

Flowchart 1300 comprises step 1302. Step 1302 is an example of step 1206 of flowchart 1200 of FIG. 12. In step 1302, a similarity threshold is set to indicate nodes that share a type without requiring the nodes to share a property. For example, structural similarity determiner 202 adjusts the structural similarity criterion to specify that a similarity threshold indicates nodes share a node type without requiring the nodes to share a property. For instance, in a non-limiting example, suppose nodes 402 and 404 share a node type and a particular property while node 406 shares the same node type but does not have the particular property (or the same value of the particular property). In this example, nodes 402 and 404 are grouped but node 406 is not. However, if structural similarity determiner 202 adjusts the structural similarity criterion to specify a similarity threshold based on node type without requiring the nodes to share the property, structural similarity determiner 202 will determine that nodes 402-406 have a level of structural similarity that satisfies the modified structural similarity criterion and graph modifier 204 will group nodes 402-406 in a grouped node.

### VI. Example Embodiments of Indicating Security Vulnerabilities

As described herein, some embodiments of attack path identifier 116 generate an indication of a security vulnerability. In accordance with an embodiment, attack path identifier 116 causes the indication to be presented to a user or a device. For instance, in accordance with an embodiment, attack path identifier 116 causes the indication to be presented in a user interface of user computing device 102 of FIG. 1 (e.g., in a user interface of application 110 or another user interface of user computing device 102). Attack path identifier 116 operates in various ways to cause such an indication to be presented, in embodiments. For example, FIG. 14 shows a flowchart 1400 of a process for presenting a security vulnerability in a user interface, in accordance with an example embodiment. In an embodiment, attack path identifier 116 of FIG. 2 operates according to flowchart 1400. Note that flowchart 1400 need not be performed in all embodiments. Further structural and operational embodiments will be apparent to persons skilled in the relevant art(s) based on the following description of FIG. 14 with respect to FIGS. 1, 2 and 4C.

Flowchart 1400 comprises step 1402. In step 1402, an indication of the security vulnerability is caused to be presented in a user interface of a computing device, the indication indicating an entry point of the security vulnerability. For example, mitigator 208 of FIG. 2 causes an indication of the security vulnerability indicated by vulnerability indication 218 to be presented in a user interface of user computing device 102 of FIG. 1. The indication indicates an entry point of the security vulnerability. For example, suppose vulnerability indication 218 indicates the computing network has a vulnerability where a malicious entity can access Key A through edge 418. In this example, mitigator 208 causes an indication to be presented in a user interface that indicates the attack path as well as potential entry points for the attack path, e.g., Virtual Machine 1, Virtual Machine 2, and/or Virtual Machine 3. By indicating potential entry points along a grouped edge in this manner, embodiments described herein are able to present a simplified indication of vulnerabilities of a computing network where a multiple attack paths targeting the same target are presented as a single attack path along with a notation (e.g., a list) of potential entry points.

### VII. Example Embodiments of Telescopic Grouping

As described herein, security system 104 generates a modified graph with reduced cardinality for use in identifying security vulnerabilities. As also described herein, e.g., with respect to flowchart 1200 of FIG. 12, some embodiments of security system 104 operate in a manner to further reduce cardinality. It is further contemplated herein that some embodiments of security system 104 generate a graph (e.g., a security graph) with telescopic grouping of nodes and/or edges. For instance, in some embodiments, graph reducer 114 generates a first modified graph that groups similar nodes into a set of grouped nodes and generates a second modified graph that groups similar groups of the set of grouped nodes into grouped groups. In this manner, a graph with telescopic grouping is generated. This enables a user or system to evaluate nodes that are similar to one another at different degrees of cardinality.

Embodiments of security system 104 operate in various ways to generate a graph with telescopic grouping. For example, FIG. 15 shows a flowchart 1500 of a process for grouping grouped nodes, in accordance with an example embodiment. In an embodiment, graph reducer 114 of FIG. 2 operates according to the steps of flowchart 1500. Note that not all steps of flowchart 1500 need be performed in all embodiments. Further structural and operational embodiments will be apparent to persons skilled in the relevant art(s) based on the following description of FIG. 15 with respect to FIG. 2.

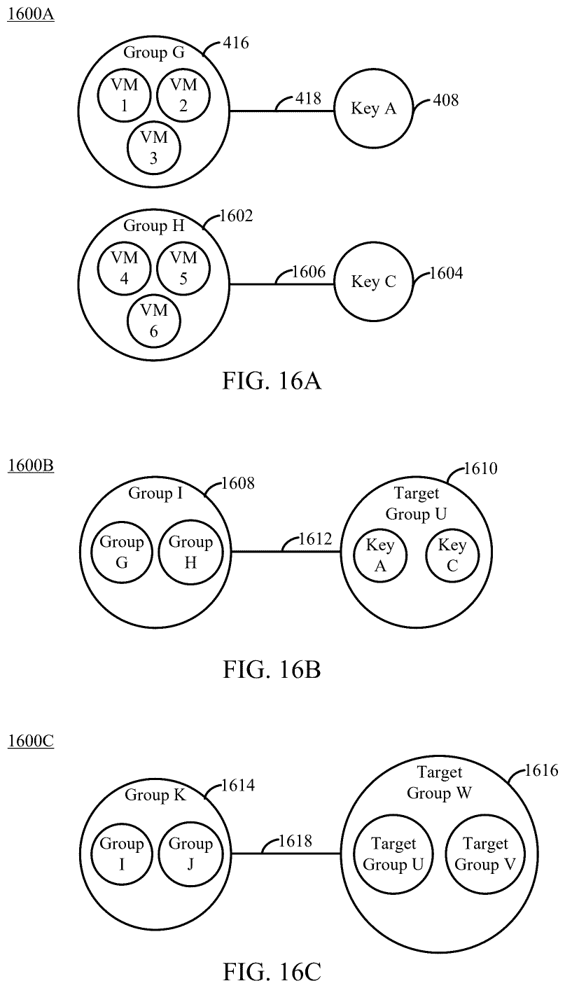

Flowchart 1500 begins with step 1502. In step 1502, a level of structural similarity between the grouped node and another grouped node is determined to satisfy a group similarity criterion. For example, structural similarity determiner 202 in an embodiment evaluates grouped nodes generated by graph modifier 204 and determines a level of structural similarity between the grouped nodes satisfies a group similarity criterion. Structural similarity determiner 202 determines a level of structural similarity between grouped nodes in various ways, in embodiments. To better understand step 1502, step 1502 is described with respect to FIG. 16A. FIG. 16A shows an example graph 1600A, in accordance with an example embodiment. As shown in FIG. 16A, graph 1600A comprises node 408, a grouped node 416, and edge 416, as described with respect to graph 400C of FIG. 4C, as well as a grouped node 1602, a node 1604, and an edge 1606. Grouped node 1602 represents a Group H of nodes representative of a Virtual Machine 4, a Virtual Machine 5, and a Virtual Machine 6, node 1604 is representative of a Key C, and edge 1606 represents a relationship between grouped node 1602 and node 1604. For example, in accordance with an embodiment edge 1606 represents that each virtual machine of Group H has access to Key C. In accordance with an embodiment, graph reducer 114 generates node 1602 and edge 1606 in a similar manner as described with respect to FIGS. 4A-4C, as well as elsewhere herein.

With continued reference to step 1502 of FIG. 15 and graph 1600A of FIG. 16A, in accordance with an embodiment, structural similarity determiner 202 determines a level of structural similarity between grouped node 416 and grouped node 1602. In accordance with an embodiment, structural similarity determiner 202 determines the structural similarity between the grouped nodes in a similar manner as determining structural similarity between individual nodes. In some embodiments, the group similarity criterion specifies a criterion for grouping nodes in a broader scope than the structural similarity criterion utilized to generate the grouped nodes. For instance, as a non-limiting example, suppose structural similarity determiner 202 determined a structural similarity of nodes representing Virtual Machines 1-3 satisfied a structural similarity criterion based on respective values of a first property and an edge having a target of node 408 and determined a structural similarity of nodes representing Virtual Machines 4-6 satisfied a structural similarity criterion based on respective values of the first property and an edge having a target of node 1604. Further suppose, in this non-limiting example, the group similarity criterion causes structural similarity determiner 202 to identify similar nodes based on having an edge that targets nodes representative of a group of keys comprising Key A and Key C. In this context, structural similarity determiner 202 determines grouped nodes 416 and 1602 have a level of structural similarity that satisfies the grouped similarity criterion.

In step 1504, the grouped node and the another grouped node are grouped in a parent grouped node, resulting in a further modified graph. For example, graph modifier 204 groups the grouped node and the another grouped node that have a level of structural similarity satisfying a group similarity criterion into a parent grouped node, resulting in a further modified graph. To better understand the operation of graph modifier 204 with respect to step 1504, step 1504 is described with respect to FIG. 16B. FIG. 16B shows an example of a graph 1600B comprising a group of grouped nodes. As shown in FIG. 16B, graph 1600B comprises a parent grouped node 1608, a grouped node 1610, and an edge 1612. In accordance with an embodiment, parent grouped node 1608 represents a Parent Group I of Groups G and H, grouped node 1610 represents a Target Group U of Keys A and C, and edge 1612 is a grouped edge representing a grouping of edges 418 and 1606 of graph 1600A. In accordance with an embodiment, graph modifier 204 groups grouped node 416 (which represents Group G) and grouped node 1602 (which represents Group H) into node 1608 (representing Parent Group I) based on the level of similarity determined in step 1502. As shown in FIG. 16B, graph modifier 204 further groups nodes 408 and 1604 into grouped node 1610 based on their structural similarity (e.g., secrets having similar properties and/or being targets of node 1608), e.g., in a similar manner as nodes 408 and 802 of FIG. 8A were grouped into grouped node 806 of FIG. 8B. As also shown in FIG. 16B, graph modifier 204 further groups edges 418 and 1606 into edge 1612 (e.g., as edges having the same origin (parent grouped node 1608) and the same target (grouped node 1610)), e.g., in a similar manner as described with respect to step 504 of flowchart 500 of FIG. 5.

Embodiments of graph reducer 114 can operate in a manner to generate several layers of telescopic graphs. For example, in accordance with an embodiment, graph reducer 114 further reduces a graph comprising parent grouped node 1608, grouped node 1610, and edge 1612 of graph 1600B into a graph 1600C of FIG. 16C. Suppose structural similarity determiner 202 of FIG. 2 determines parent grouped node 1608 is structurally similar to another parent grouped node representative of a Parent Group J and graph modifier 204 groups the nodes as grouped node 1614 representative of a Group K comprising nodes of Parent Groups I and J. In this context, structural similarity determiner 202 determines Parent Group I is distinct from Parent Group J at a first level of similarity but similar to Parent Group J at a second level of similarity with broader criteria than the first level of similarity. For instance, as a non-limiting example, suppose nodes of Parent Group I do not have similar properties as nodes of Parent Group J; however, nodes of Parent Group I are the same type of node as nodes of Parent Group J. In this context, graph modifier 204 groups Parent Groups I and J at a degree of similarity based on the type of their nodes. In this context, a telescopic graph is generated such that a high level view showing resources of the system grouped on type shows grouped node 1614 representative of Group K, a lower level view requiring a higher level of similarity to group nodes shows node 1608 and a node representative of Group J, a next lower level view requiring a higher level of similarity to group nodes shows grouped nodes representative of Group G, Group H, and sub-groups of Group J (not shown in FIGS. 16A-16C for brevity), and a lowest level view shows the individual nodes of Group G (e.g., nodes representative of Virtual Machines 1-3), Group H (e.g., nodes representative of Virtual Machines 4-6), and sub-groups of Group J (not shown in FIGS. 16A-16C for brevity).

As shown in FIG. 16C, graph 1600C shows grouped node 1614, target grouped node 1616, and edge 1618. Target grouped node 1616 represents Target Group W comprising grouped node 1610 and the grouped node representative of Target Group V. In accordance with an embodiment Target Group V comprises one or more target(s) of Group J. In accordance with a further embodiment, structural similarity determiner 202 determines a structural similarity between node 1610 and the node representative of Target Group V and graph modifier 202 groups the nodes as node 1616.

Thus, an example of telescopic grouping of nodes has been described with respect to FIGS. 15-16C. In accordance with an embodiment, security system 104 causes the telescopic grouping of nodes to be presented in a user interface of a computing device, e.g., a user interface of computing device 102. In this context, a user is able to interact with the representation of the telescopic grouping of nodes to observe different levels of the graph in a digestible manner. For instance, the representation of the telescopic grouping of nodes as shown in graph 1600C would represent a less complex grouping of nodes and interconnection of edges than if each individual node and edge were represented separately in the graph. In this context, a user is able to select a grouping of nodes (e.g., by interacting with the grouped node in the user interface) and see the next layer of nodes. For instance, suppose graph 1600C is presented in a user interface of computing device 102. In this context, a user is able to interact with node 1614 and, optionally, cause the user interface to present graph 1600B (and, optionally, a representation of the node representing Group J and its relationship to the node representing Target Group V). The user can review deeper representations of nodes by further interacting (e.g., selecting a graphic representation using a pointing device) with parent grouped node 1608 (or another parent grouped node), causing the user interface to display graph 1600A of FIG. 16A. Further interaction with grouped nodes 416 and 1602, or similar grouped nodes, is also contemplated herein. Moreover, in some embodiments, a user is able to interact with a target grouped node (e.g., target grouped node 1616, target grouped node 1610, and/or the like) to evaluate nodes and/or grouped nodes that have the target grouped node and/or nodes thereof as targets. By grouping nodes in different levels of similarity, embodiments described herein improve a user interface by reducing the complexity in presented information at a higher level and enabling a user to selectively focus on subgroupings of nodes, respective edges, and respective target nodes in evaluation thereof. In some embodiments, this reduces the amount of information displayed in a user interface.

While several examples have been described herein with respect to a user reviewing a telescopic graph in a user interface of a computing device, embodiments described herein are not so limited. For instance, in accordance with an embodiment, security vulnerability identifier 206 of FIG. 2 identifies a security vulnerability based on a telescopic graph. As a non-limiting example, suppose security vulnerability identifier 206 identifies a security vulnerability with respect to grouped node 416 of FIG. 16A. In this example, security vulnerability identifier 206 determines that grouped node 416 is a sub-group of grouped node 1608 and further evaluates grouped node 1608 to determine if any other nodes and/or sub-groups of grouped node 1608 are exposed to the security vulnerability of node 416 and/or security vulnerabilities similar to the identified security vulnerability. In accordance with another example, suppose security vulnerability identifier 206 determines that grouped node 1614 of FIG. 16C is associated with a potential security vulnerability. In this other example, security vulnerability identifier 206 evaluates sub-groups of grouped node 1614 (e.g., Group I, Group J, sub-groups of Groups I and J) to determine respective levels of severity in impact the security vulnerability poses to the sub-groups and/or nodes. By generating a telescopic graph in the manners described herein, embodiments enable security vulnerability identifier 206 to evaluate a high level graph (e.g., such as graph 1600C) for security vulnerabilities, identify a security vulnerability of a grouped node, and evaluate the grouped node at a lower levels of graphs (e.g., such as graphs 1600B, 1600A, 400C, 400B, 400A, and/or the like) to further evaluate the identified security vulnerability to determine a mitigation step to be performed. This reduces compute resources and time utilized to identify a security vulnerability, as security vulnerability identifier 206 evaluates fewer nodes and edges in the high level graph than if the individual nodes and edges were ungrouped.

### VIII. Example Computer System Implementation

Embodiments of cardinality reduction in graphs described herein are implemented in hardware, or hardware combined with one or both of software and/or firmware. For example application 110, graph generator 112, graph reducer 114, attack path identifier 116, virtual machine 128, virtual machine 130, virtual machine 132, structural similarity determiner 202, graph modifier 204, security vulnerability identifier 206, mitigator 208, Virtual Machine 1, Virtual Machine 2, Virtual Machine 3, feature determiner 902, embedding generator 904, vector evaluator 906, embedding model 926, Virtual Machine 4, Virtual Machine 5, Virtual Machine 6, and/or the components described therein, and/or the steps of flowcharts 300, 400, 500, 600, 700, 1000, 1100, 1200, 1300, 1400, and/or 1500, are each implemented as computer program code/instructions configured to be executed in one or more processors and stored in a computer readable storage medium. Alternatively, user computing device 102, security system 104, storage 106, graph generator 112, graph reducer 114, attack path identifier 116, server 124A, server 124B, server 124C, server 124n, structural similarity determiner 202, graph modifier 204, security vulnerability identifier 206, mitigator 208, Virtual Machine 1, Virtual Machine 2, Virtual Machine 3, feature determiner 902, embedding generator 904, vector evaluator 906, embedding model 926, Virtual Machine 4, Virtual Machine 5, Virtual Machine 6, and/or the components described therein, and/or the steps of flowcharts 300, 400, 500, 600, 700, 1000, 1100, 1200, 1300, 1400, and/or 1500, are implemented in one or more SoCs (system on chip). An SoC includes an integrated circuit chip that includes one or more of a processor (e.g., a central processing unit (CPU), microcontroller, microprocessor, digital signal processor (DSP), etc.), memory, one or more communication interfaces, and/or further circuits, and optionally executes received program code and/or include embedded firmware to perform functions.

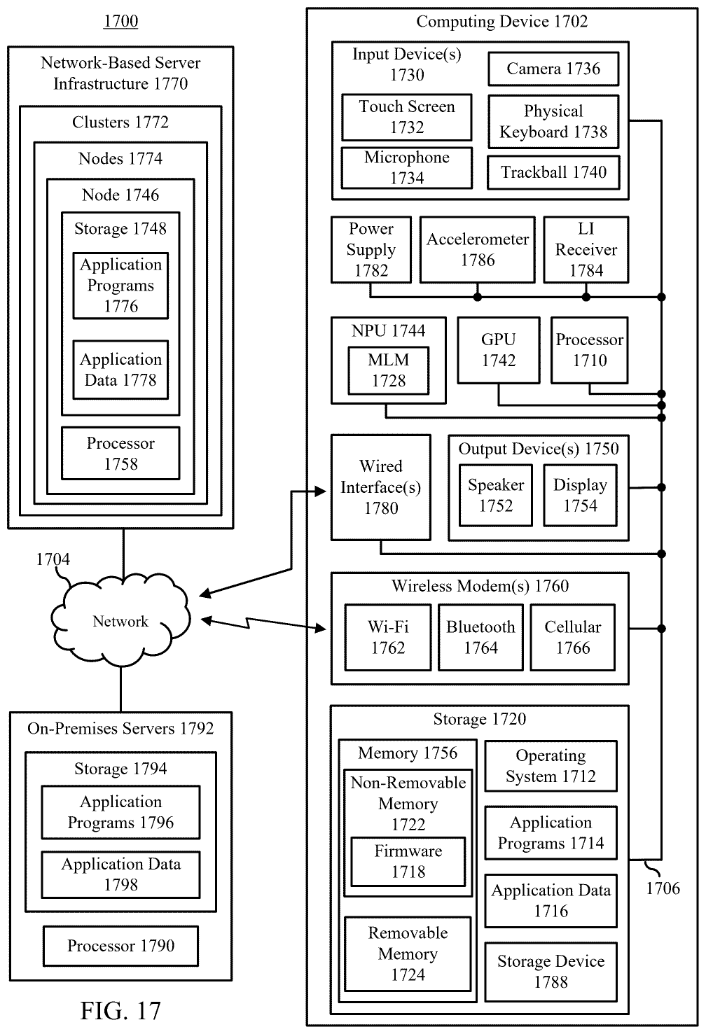

Embodiments disclosed herein can be implemented in one or more computing devices that are mobile (a mobile device) and/or stationary (a stationary device) and include any combination of the features of such mobile and stationary computing devices. Examples of computing devices in which embodiments are implementable are described as follows with respect to FIG. 17. FIG. 17 shows a block diagram of an exemplary computing environment 1700 that includes a computing device 1702. Computing device 1702 is an example of user computing device 102, security system 104, storage 106, server 124A, server 124B, server 124C, and/or server 124n, which each include one or more of the components of computing device 1702. In some embodiments, computing device 1702 is communicatively coupled with devices (not shown in FIG. 17) external to computing environment 1700 via network 1704. Network 1704 comprises one or more networks such as local area networks (LANs), wide area networks (WANs), enterprise networks, the Internet, etc. In examples, network 1704 includes one or more wired and/or wireless portions. In some examples, network 1704 additionally or alternatively includes a cellular network for cellular communications. Network 1704 is an example of network 118, in an embodiment. Computing device 1702 is described in detail as follows.

Computing device 1702 can be any of a variety of types of computing devices. Examples of computing device 1702 include a mobile computing device such as a handheld computer (e.g., a personal digital assistant (PDA)), a laptop computer, a tablet computer, a hybrid device, a notebook computer, a netbook, a mobile phone (e.g., a cell phone, a smart phone, etc.), a wearable computing device (e.g., a head-mounted augmented reality and/or virtual reality device including smart glasses), or other type of mobile computing device. In an alternative example, computing device 1702 is a stationary computing device such as a desktop computer, a personal computer (PC), a stationary server device, a minicomputer, a mainframe, a supercomputer, etc.

As shown in FIG. 17, computing device 1702 includes a variety of hardware and software components, including a processor 1710, a storage 1720, a graphics processing unit (GPU) 1742, a neural processing unit (NPU) 1744, one or more input devices 1730, one or more output devices 1750, one or more wireless modems 1760, one or more wired interfaces 1780, a power supply 1782, a location information (LI) receiver 1784, and an accelerometer 1786. Storage 1720 includes memory 1756, which includes non-removable memory 1722 and removable memory 1724, and a storage device 1788. Storage 1720 also stores an operating system 1712, application programs 1714, and application data 1716. Wireless modem(s) 1760 include a Wi-Fi modem 1762, a Bluetooth modem 1764, and a cellular modem 1766. Output device(s) 1750 includes a speaker 1752 and a display 1754. Input device(s) 1730 includes a touch screen 1732, a microphone 1734, a camera 1736, a physical keyboard 1738, and a trackball 1740. Not all components of computing device 1702 shown in FIG. 17 are present in all embodiments, additional components not shown may be present, and in a particular embodiment any combination of the components are present. In examples, components of computing device 1702 are mounted to a circuit card (e.g., a motherboard) of computing device 1702, integrated in a housing of computing device 1702, or otherwise included in computing device 1702. The components of computing device 1702 are described as follows.

In embodiments, a single processor 1710 (e.g., central processing unit (CPU), microcontroller, a microprocessor, signal processor, ASIC (application specific integrated circuit), and/or other physical hardware processor circuit) or multiple processors 1710 are present in computing device 1702 for performing such tasks as program execution, signal coding, data processing, input/output processing, power control, and/or other functions. In examples, processor 1710 is a single-core or multi-core processor, and each processor core is single-threaded or multithreaded (to provide multiple threads of execution concurrently). Processor 1710 is configured to execute program code stored in a computer readable medium, such as program code of operating system 1712 and application programs 1714 stored in storage 1720. The program code is structured to cause processor 1710 to perform operations, including the processes/methods disclosed herein. Operating system 1712 controls the allocation and usage of the components of computing device 1702 and provides support for one or more application programs 1714 (also referred to as “applications” or “apps”). In examples, application programs 1714 include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein. In examples, processor(s) 1710 includes one or more general processors (e.g., CPUs) configured with or coupled to one or more hardware accelerators, such as one or more NPUs 1744 and/or one or more GPUs 1742.

Any component in computing device 1702 can communicate with any other component according to function, although not all connections are shown for ease of illustration. For instance, as shown in FIG. 17, bus 1706 is a multiple signal line communication medium (e.g., conductive traces in silicon, metal traces along a motherboard, wires, etc.) present to communicatively couple processor 1710 to various other components of computing device 1702, although in other embodiments, an alternative bus, further buses, and/or one or more individual signal lines is/are present to communicatively couple components. Bus 1706 represents one or more of any of several types of bus structures, including a memory bus or memory controller, a peripheral bus, an accelerated graphics port, and a processor or local bus using any of a variety of bus architectures.

Storage 1720 is physical storage that includes one or both of memory 1756 and storage device 1788, which store operating system 1712, application programs 1714, and application data 1716 according to any distribution. Non-removable memory 1722 includes one or more of RAM (random access memory), ROM (read only memory), flash memory, a solid-state drive (SSD), a hard disk drive (e.g., a disk drive for reading from and writing to a hard disk), and/or other physical memory device type. In examples, non-removable memory 1722 includes main memory and is separate from or fabricated in a same integrated circuit as processor 1710. As shown in FIG. 17, non-removable memory 1722 stores firmware 1718 that is present to provide low-level control of hardware. Examples of firmware 1718 include BIOS (Basic Input/Output System, such as on personal computers) and boot firmware (e.g., on smart phones). In examples, removable memory 1724 is inserted into a receptacle of or is otherwise coupled to computing device 1702 and can be removed by a user from computing device 1702. Removable memory 1724 can include any suitable removable memory device type, including an SD (Secure Digital) card, a Subscriber Identity Module (SIM) card, which is well known in GSM (Global System for Mobile Communications) communication systems, and/or other removable physical memory device type. In examples, one or more of storage device 1788 are present that are internal and/or external to a housing of computing device 1702 and are or are not removable. Examples of storage device 1788 include a hard disk drive, a SSD, a thumb drive (e.g., a USB (Universal Serial Bus) flash drive), or other physical storage device.

One or more programs are stored in storage 1720. Such programs include operating system 1712, one or more application programs 1714, and other program modules and program data. Examples of such application programs include computer program logic (e.g., computer program code/instructions) for implementing application 110, graph generator 112, graph reducer 114, attack path identifier 116, virtual machine 128, virtual machine 130, virtual machine 132, structural similarity determiner 202, graph modifier 204, security vulnerability identifier 206, mitigator 208, Virtual Machine 1, Virtual Machine 2, Virtual Machine 3, feature determiner 902, embedding generator 904, vector evaluator 906, embedding model 926, Virtual Machine 4, Virtual Machine 5, Virtual Machine 6, and/or the components described therein, and/or the steps of flowcharts 300, 400, 500, 600, 700, 1000, 1100, 1200, 1300, 1400, and/or 1500.

Storage 1720 also stores data used and/or generated by operating system 1712 and application programs 1714 as application data 1716. Examples of application data 1716 include web pages, text, images, tables, sound files, video data, and other data. In examples, application data 1716 is sent to and/or received from one or more network servers or other devices via one or more wired or wireless networks. Storage 1720 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

In examples, a user enters commands and information into computing device 1702 through one or more input devices 1730 and receives information from computing device 1702 through one or more output devices 1750. For example, in a non-limiting example, display 1754 displays an indication of a security vulnerability in a user interface. In another non-limiting example, display 1754 display any of graphs 400A, 400B, 400C, 800A, 800B, 1600A, 1600B, and/or 1600C in a user interface. Input device(s) 1730 includes one or more of touch screen 1732, microphone 1734, camera 1736, physical keyboard 1738 and/or trackball 1740 and output device(s) 1750 includes one or more of speaker 1752 and display 1754. Each of input device(s) 1730 and output device(s) 1750 are integral to computing device 1702 (e.g., built into a housing of computing device 1702) or are external to computing device 1702 (e.g., communicatively coupled wired or wirelessly to computing device 1702 via wired interface(s) 1780 and/or wireless modem(s) 1760). Further input devices 1730 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 1754 displays information, as well as operating as touch screen 1732 by receiving user commands and/or other information (e.g., by touch, finger gestures, virtual keyboard, etc.) as a user interface. Any number of each type of input device(s) 1730 and output device(s) 1750 are present, including multiple microphones 1734, multiple cameras 1736, multiple speakers 1752, and/or multiple displays 1754.

In embodiments where GPU 1742 is present, GPU 1742 includes hardware (e.g., one or more integrated circuit chips that implement one or more of processing cores, multiprocessors, compute units, etc.) configured to accelerate computer graphics (two-dimensional (2D) and/or three-dimensional (3D)), perform image processing, and/or execute further parallel processing applications (e.g., training of neural networks, etc.). Examples of GPU 1742 perform calculations related to 3D computer graphics, include 2D acceleration and framebuffer capabilities, accelerate memory-intensive work of texture mapping and rendering polygons, accelerate geometric calculations such as the rotation and translation of vertices into different coordinate systems, support programmable shaders that manipulate vertices and textures, perform oversampling and interpolation techniques to reduce aliasing, and/or support very high-precision color spaces.

In examples, NPU 1744 (also referred to as an “artificial intelligence (AI) accelerator” or “deep learning processor (DLP)”) is a processor or processing unit configured to accelerate artificial intelligence and machine learning applications, such as execution of machine learning (ML) model (MLM) 1728. In an example, NPU 1744 is configured for a data-driven parallel computing and is highly efficient at processing massive multimedia data such as videos and images and processing data for neural networks. NPU 1744 is configured for efficient handling of AI-related tasks, such as speech recognition, background blurring in video calls, photo or video editing processes like object detection, etc.

In embodiments disclosed herein that implement ML models, NPU 1744 can be utilized to execute such ML models, of which MLM 1728 is an example. In an embodiment, MLM 1728 is a further example of embedding model 926. For instance, where applicable, MLM 1728 is a generative AI model that generates content that is complex, coherent, and/or original. For instance, a generative AI model can create sophisticated sentences, lists, ranges, tables of data, images, essays, and/or the like. An example of a generative AI model is a language model. A language model is a model that estimates the probability of a token or sequence of tokens occurring in a longer sequence of tokens. In this context, a “token” is an atomic unit that the model is training on and making predictions on. Examples of a token include, but are not limited to, a word, a character (e.g., an alphanumeric character, a blank space, a symbol, etc.), a sub-word (e.g., a root word, a prefix, or a suffix). In other types of models (e.g., image based models) a token may represent another kind of atomic unit (e.g., a subset of an image). Examples of language models applicable to embodiments herein include large language models (LLMs), text-to-image AI image generation systems, text-to-video AI generation systems, etc. A large language model (LLM) is a language model that has a high number of model parameters. In examples, an LLM has millions, billions, trillions, or even greater numbers of model parameters. Model parameters of an LLM are the weights and biases the model learns during training. Some implementations of LLMs are transformer-based LLMs (e.g., the family of generative pre-trained transformer (GPT) models). A transformer is a neural network architecture that relies on self-attention mechanisms to transform a sequence of input embeddings into a sequence of output embeddings (e.g., without relying on convolutions or recurrent neural networks).

In further examples, NPU 1744 is used to train MLM 1728. To train MLM 1728, training data is that includes input features (attributes) and their corresponding output labels/target values (e.g., for supervised learning) is collected. A training algorithm is a computational procedure that is used so that MLM 1728 learns from the training data. Parameters/weights are internal settings of MLM 1728 that are adjusted during training by the training algorithm to reduce a difference between predictions by MLM 1728 and actual outcomes (e.g., output labels). In some examples, MLM 1728 is set with initial values for the parameters/weights. A loss function measures a dissimilarity between predictions by MLM 1728 and the target values, and the parameters/weights of MLM 1728 are adjusted to minimize the loss function. The parameters/weights are iteratively adjusted by an optimization technique, such as gradient descent. In this manner, MLM 1728 is generated through training by NPU 1744 to be used to generate inferences based on received input feature sets for particular applications. MLM 1728 is generated as a computer program or other type of algorithm configured to generate an output (e.g., a classification, a prediction/inference) based on received input features, and is stored in the form of a file or other data structure.

In examples, such training of MLM 1728 by NPU 1744 is supervised or unsupervised. According to supervised learning, input objects (e.g., a vector of predictor variables) and a desired output value (e.g., a human-labeled supervisory signal) train MLM 1728. The training data is processed, building a function that maps new data on expected output values. Example algorithms usable by NPU 1744 to perform supervised training of MLM 1728 in particular implementations include support-vector machines, linear regression, logistic regression, Naïve Bayes, linear discriminant analysis, decision trees, K-nearest neighbor algorithm, neural networks, and similarity learning.

In an example of supervised learning where MLM 1728 is an LLM, MLM 1728 can be trained by exposing the LLM to (e.g., large amounts of) text (e.g., predetermined datasets, books, articles, text-based conversations, webpages, transcriptions, forum entries, and/or any other form of text and/or combinations thereof). In examples, training data is provided from a database, from the Internet, from a system, and/or the like. Furthermore, an LLM can be fine-tuned using Reinforcement Learning with Human Feedback (RLHF), where the LLM is provided the same input twice and provides two different outputs and a user ranks which output is preferred. In this context, the user's ranking is utilized to improve the model. Further still, in example embodiments, an LLM is trained to perform in various styles, e.g., as a completion model (a model that is provided a few words or tokens and generates words or tokens to follow the input), as a conversation model (a model that provides an answer or other type of response to a conversation-style prompt), as a combination of a completion and conversation model, or as another type of LLM model.

According to unsupervised learning, MLM 1728 is trained to learn patterns from unlabeled data. For instance, in embodiments where MLM 1728 implements unsupervised learning techniques, MLM 1728 identifies one or more classifications or clusters to which an input belongs. During a training phase of MLM 1728 according to unsupervised learning, MLM 1728 tries to mimic the provided training data and uses the error in its mimicked output to correct itself (i.e., correct weights and biases). In further examples, NPU 1744 perform unsupervised training of MLM 1728 according to one or more alternative techniques, such as Hopfield learning rule, Boltzmann learning rule, Contrastive Divergence, Wake Sleep, Variational Inference, Maximum Likelihood, Maximum A Posteriori, Gibbs Sampling, and backpropagating reconstruction errors or hidden state reparameterizations.

Note that NPU 1744 need not necessarily be present in all ML model embodiments. In embodiments where ML models are present, any one or more of processor 1710, GPU 1742, and/or NPU 1744 can be present to train and/or execute MLM 1728.

One or more wireless modems 1760 can be coupled to antenna(s) (not shown) of computing device 1702 and can support two-way communications between processor 1710 and devices external to computing device 1702 through network 1704, as would be understood to persons skilled in the relevant art(s). Wireless modem 1760 is shown generically and can include a cellular modem 1766 for communicating with one or more cellular networks, such as a GSM network for data and voice communications within a single cellular network, between cellular networks, or between the mobile device and a public switched telephone network (PSTN). In examples, wireless modem 1760 also or alternatively includes other radio-based modem types, such as a Bluetooth modem 1764 (also referred to as a “Bluetooth device”) and/or Wi-Fi modem 1762 (also referred to as an “wireless adaptor”). Wi-Fi modem 1762 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 1764 is configured to communicate with another Bluetooth-capable device according to the Bluetooth short-range wireless technology standard(s) such as IEEE 802.15.1 and/or managed by the Bluetooth Special Interest Group (SIG).

Computing device 1702 can further include power supply 1782, LI receiver 1784, accelerometer 1786, and/or one or more wired interfaces 1780. Example wired interfaces 1780 include a USB port, IEEE 1794 (FireWire) port, a RS-232 port, an HDMI (High-Definition Multimedia Interface) port (e.g., for connection to an external display), a DisplayPort port (e.g., for connection to an external display), an audio port, and/or an Ethernet port, the purposes and functions of each of which are well known to persons skilled in the relevant art(s). Wired interface(s) 1780 of computing device 1702 provide for wired connections between computing device 1702 and network 1704, or between computing device 1702 and one or more devices/peripherals when such devices/peripherals are external to computing device 1702 (e.g., a pointing device, display 1754, speaker 1752, camera 1736, physical keyboard 1738, etc.). Power supply 1782 is configured to supply power to each of the components of computing device 1702 and receives power from a battery internal to computing device 1702, and/or from a power cord plugged into a power port of computing device 1702 (e.g., a USB port, an A/C power port). LI receiver 1784 is useable for location determination of computing device 1702 and in examples includes a satellite navigation receiver such as a Global Positioning System (GPS) receiver and/or includes other type of location determiner configured to determine location of computing device 1702 based on received information (e.g., using cell tower triangulation, etc.). Accelerometer 1786, when present, is configured to determine an orientation of computing device 1702.

Note that the illustrated components of computing device 1702 are not required or all-inclusive, and fewer or greater numbers of components can be present as would be recognized by one skilled in the art. In examples, computing device 1702 includes one or more of a gyroscope, barometer, proximity sensor, ambient light sensor, digital compass, etc. In an example, processor 1710 and memory 1756 are co-located in a same semiconductor device package, such as being included together in an integrated circuit chip, FPGA, or system-on-chip (SOC), optionally along with further components of computing device 1702.

In embodiments, computing device 1702 is configured to implement any of the above-described features of flowcharts herein. Computer program logic for performing any of the operations, steps, and/or functions described herein is stored in storage 1720 and executed by processor 1710.

In some embodiments, server infrastructure 1770 is present in computing environment 1700 and is communicatively coupled with computing device 1702 via network 1704. Server infrastructure 1770, when present, is a network-accessible server set (e.g., a cloud-based environment or platform). As shown in FIG. 17, server infrastructure 1770 includes clusters 1772. Each of clusters 1772 comprises a group of one or more compute nodes and/or a group of one or more storage nodes. For example, as shown in FIG. 17, cluster 1772 includes nodes 1774. Each of nodes 1774 are accessible via network 1704 (e.g., in a “cloud-based” embodiment) to build, deploy, and manage applications and services. In examples, any of nodes 1774 is a storage node that comprises a plurality of physical storage disks, SSDs, and/or other physical storage devices that are accessible via network 1704 and are configured to store data associated with the applications and services managed by nodes 1774.

Each of nodes 1774, as a compute node, comprises one or more server computers, server systems, and/or computing devices. For instance, a node 1774 in accordance with an embodiment includes one or more of the components of computing device 1702 disclosed herein. Each of nodes 1774 is configured to execute one or more software applications (or “applications”) and/or services and/or manage hardware resources (e.g., processors, memory, etc.), which are utilized by users (e.g., customers) of the network-accessible server set. In examples, as shown in FIG. 17, nodes 1774 includes a node 1746 that includes storage 1748 and/or one or more of a processor 1758 (e.g., similar to processor 1710, GPU 1742, and/or NPU 1744 of computing device 1702). Storage 1748 stores application programs 1776 and application data 1778. Processor(s) 1758 operate application programs 1776 which access and/or generate related application data 1778. In an implementation, nodes such as node 1746 of nodes 1774 operate or comprise one or more virtual machines, with each virtual machine emulating a system architecture (e.g., an operating system), in an isolated manner, upon which applications such as application programs 1776 are executed.

In embodiments, one or more of clusters 1772 are located/co-located (e.g., housed in one or more nearby buildings with associated components such as backup power supplies, redundant data communications, environmental controls, etc.) to form a datacenter, or are arranged in other manners. Accordingly, in an embodiment, one or more of clusters 1772 are included in a datacenter in a distributed collection of datacenters. In embodiments, exemplary computing environment 1700 comprises part of a cloud-based platform.

In an embodiment, computing device 1702 accesses application programs 1776 for execution in any manner, such as by a client application and/or a browser at computing device 1702.

In an example, for purposes of network (e.g., cloud) backup and data security, computing device 1702 additionally and/or alternatively synchronizes copies of application programs 1714 and/or application data 1716 to be stored at network-based server infrastructure 1770 as application programs 1776 and/or application data 1778. In examples, operating system 1712 and/or application programs 1714 include a file hosting service client configured to synchronize applications and/or data stored in storage 1720 at network-based server infrastructure 1770.

In some embodiments, on-premises servers 1792 are present in computing environment 1700 and are communicatively coupled with computing device 1702 via network 1704. On-premises servers 1792, when present, are hosted within an organization's infrastructure and, in many cases, physically onsite of a facility of that organization. On-premises servers 1792 are controlled, administered, and maintained by IT (Information Technology) personnel of the organization or an IT partner to the organization. Application data 1798 can be shared by on-premises servers 1792 between computing devices of the organization, including computing device 1702 (when part of an organization) through a local network of the organization, and/or through further networks accessible to the organization (including the Internet). Furthermore, in examples, on-premises servers 1792 serve applications such as application programs 1796 to the computing devices of the organization, including computing device 1702. Accordingly, in examples, on-premises servers 1792 include storage 1794 (which includes one or more physical storage devices such as storage disks and/or SSDs) for storage of application programs 1796 and application data 1798 and include a processor 1790 (e.g., similar to processor 1710, GPU 1742, and/or NPU 1744 of computing device 1702) for execution of application programs 1796. In some embodiments, multiple processors 1790 are present for execution of application programs 1796 and/or for other purposes. In further examples, computing device 1702 is configured to synchronize copies of application programs 1714 and/or application data 1716 for backup storage at on-premises servers 1792 as application programs 1796 and/or application data 1798.

Embodiments described herein may be implemented in one or more of computing device 1702, network-based server infrastructure 1770, and on-premises servers 1792. For example, in some embodiments, computing device 1702 is used to implement systems, clients, or devices, or components/subcomponents thereof, disclosed elsewhere herein. In other embodiments, a combination of computing device 1702, network-based server infrastructure 1770, and/or on-premises servers 1792 is used to implement the systems, clients, or devices, or components/subcomponents thereof, disclosed elsewhere herein.

As used herein, the terms “computer program medium,” “computer-readable medium,” “computer-readable storage medium,” and “computer-readable storage device,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 1720. Such computer-readable media and/or storage media are distinguished from and non-overlapping with communication media, propagating signals, and signals per se. Stated differently, “computer program medium,” “computer-readable medium,” “computer-readable storage medium,” and “computer-readable storage device” do not encompass communication media, propagating signals, and signals per se. Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared, and other wireless media, as well as wired media. Embodiments are also directed to such communication media that are separate and non-overlapping with embodiments directed to computer-readable storage media.

As noted above, computer programs and modules (including application programs 1714) are stored in storage 1720. Such computer programs can also be received via wired interface(s) 1760 and/or wireless modem(s) 1760 over network 1704. Such computer programs, when executed or loaded by an application, enable computing device 1702 to implement features of embodiments discussed herein. Accordingly, such computer programs represent controllers of the computing device 1702.

Embodiments are also directed to computer program products comprising computer code or instructions stored on any computer-readable medium or computer-readable storage medium. Such computer program products include the physical storage of storage 1720 as well as further physical storage types.

### IX. Additional Example Embodiments

A system is described herein. The system comprises a processor and memory. The memory comprises program code. The program code comprises a graph generator, a graph reducer, and an attack path identifier. The graph generator generates a graph representative of resources in the network-based computing system, the graph comprising nodes representative of the resources and edges between nodes representing respective attack paths between respective nodes. The graph reducer determines a level of structural similarity between a first node and a second node of the nodes satisfies a structural similarity criterion and generates a modified graph. The attack path identifier identifies a security vulnerability of the network-based computing system based on the modified graph and causes mitigation of the security vulnerability.

In a further example of the foregoing system, the graph reducer groups the first node and the second node together in a grouped node, resulting in the modified graph.

In a further example of the foregoing system, the graph reducer groups a first edge associated with the first node and a second edge associated with the second node together in a grouped edge, resulting in the modified graph.

In a further example of the foregoing system, the graph reducer identifies the first edge of the first node having a third node as a target and identifies the second edge of the second node having the third node as a target. The graph reducer groups the first and second edges as a grouped edge.

In a further example of the foregoing system, the graph reducer determines a level of structural similarity between the third node and a fourth node and groups the third and fourth nodes as a grouped target. In a further example of the foregoing system, the attack path identifier mitigates the security vulnerability with respect to the grouped target.

In a further example of the foregoing system, the attack path identifier identifies a key accessible to the grouped node and determines a number of nodes of the grouped node satisfies a vulnerability criterion.

In a further example of the foregoing system, the graph reducer generates a first sparse vector based on a property and an edge of the first node, generates a second sparse vector based on a property and an edge of the second node, and determines a distance between the first sparse vector and the second sparse vector satisfies the structural similarity criterion.

In a further example of the foregoing system, the graph reducer utilizes an embedding model to generate the first and second sparse vectors.

In a further example of the foregoing system, the graph reducer determines a level of structural similarity between the first node and a third node fails to satisfy the structural similarity criterion, determines a cardinality of the modified graph fails to satisfy a cardinality criterion, and adjusts the structural similarity criterion, resulting in a modified structural similarity criterion. The graph reducer determines the level of structural similarity between the first node and the third node satisfies the modified structural similarity criterion and groups the first node, the second node, and the third node in the grouped node. The graph reducer determines the cardinality of the modified graph satisfies the cardinality criterion.

In a further example of the foregoing system, the graph reducer sets a similarity threshold indicative of nodes that share a type but do not share a property.

In a further example of the foregoing system, the attack path identifier causes an indication of the security vulnerability to be presented in a user interface of a computing device, the indication indicating an entry point of the security vulnerability.

A method for mitigating security vulnerabilities in a network-based computing system is described herein. The method comprises: generating a graph representative of resources in the network-based computing system, the graph comprising nodes representative of the resources and edges between nodes representing respective attack paths between respective nodes; determining a level of structural similarity between a first node and a second node of the nodes satisfies a structural similarity criterion; generating a modified graph based on the determination that the level of structural similarity satisfies a structural similarity criterion; identifying a security vulnerability of the network-based computing system based on the modified graph; and causing mitigation of the security vulnerability.

In a further example of the foregoing method, the method further comprises: grouping the first node and the second node together in a grouped node, resulting in a modified graph;

In a further example of the foregoing method, the method further comprises: grouping a first edge associated with the first node and a second edge associated with the second node as a grouped edge.

In a further example of the foregoing method, the method further comprises: identifying a first edge of the first node having a third node as a target; identifying a second edge of the second node having the third node as a target; and grouping the first and second edges as a grouped edge.

In a further example of the foregoing method, the method further comprises: determining a level of structural similarity between the third node and a fourth node; grouping the third and fourth nodes as a grouped target; and mitigating the security vulnerability with respect to the grouped target.

In a further example of the foregoing method, said identifying the security vulnerability comprises: identifying a key accessible to the grouped node; and determining a number of nodes of the grouped node satisfies a vulnerability criterion.

In a further example of the foregoing method, said determining the level of structural similarity between the first node and the second node comprises: generating a first sparse vector based on a property and an edge of the first node; generating a second sparse vector based on a property and an edge of the second node; and determining a distance between the first sparse vector and the second sparse vector satisfies the structural similarity criterion.

In a further example of the foregoing method, the method further comprises: determining a level of structural similarity between the first node and a third node fails to satisfy the structural similarity criterion; determining a cardinality of the modified graph fails to satisfy a cardinality criterion; adjusting the structural similarity criterion, resulting in a modified structural similarity criterion; determining the level of structural similarity between the first node and the third node satisfies the modified structural similarity criterion; grouping the first node, the second node, and the third node in the grouped node; and determining the cardinality of the modified graph satisfies the cardinality criterion.

In a further example of the foregoing method, said adjusting the structural similarity criterion comprises: setting a similarity threshold indicative of nodes that share a type but do not share a property.

In a further example of the foregoing method, the method further comprises: causing an indication of the security vulnerability to be presented in a user interface of a computing device, the indication indicating an entry point of the security vulnerability.

A computer readable storage medium is described herein. The computer readable storage medium comprising programming instructions encoded thereon. The programming instructions structured to cause a processor to perform any of the foregoing methods.

### X. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the discussion, unless otherwise stated, adjectives modifying a condition or relationship characteristic of a feature or features of an implementation of the disclosure, should be understood to mean that the condition or characteristic is defined to within tolerances that are acceptable for operation of the implementation for an application for which it is intended. Furthermore, if the performance of an operation is described herein as being “in response to” one or more factors, it is to be understood that the one or more factors may be regarded as a sole contributing factor for causing the operation to occur or a contributing factor along with one or more additional factors for causing the operation to occur, and that the operation may occur at any time upon or after establishment of the one or more factors. Still further, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

Numerous example embodiments have been described above. Any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

Furthermore, example embodiments have been described above with respect to one or more running examples. Such running examples describe one or more particular implementations of the example embodiments; however, embodiments described herein are not limited to these particular implementations.

Moreover, according to the described embodiments and techniques, any components of systems, applications, computing devices, security systems, servers, storages, graph generators, graph reducers, attack path identifiers, embedding models, and their functions may be caused to be activated for operation/performance thereof based on other operations, functions, actions, and/or the like, including initialization, completion, and/or performance of the operations, functions, actions, and/or the like.

Still further, several example embodiments have been described herein with respect to generating graphs for the purpose of detecting security vulnerabilities in a computing system. However, it is also contemplated herein that embodiments of graph generators and graph reducers can be utilized to reduce cardinality in graphs representative of network-based computing systems for other uses as well. For instance, in accordance with an embodiment, a graph generator and a graph reducer reduce cardinality in an asset graph utilized for monitoring data flow in a computing network, execution of code in the computing network, development operations performed with respect to the computing network, and/or the like. Such embodiments utilize graph reducers in a similar manner as described herein to reduce the compute resources utilized to identify a flow of data from a node and/or grouped node to another node and/or grouped node, identify the propagation of executed code with respect to nodes and/or grouped nodes, identify impact of a development operation on a node and/or grouped node, and/or the like. Furthermore, visual representations of data flow, code execution, operation performance, and/or the like can be simplified in order to improve representation in a user interface. Further still, such embodiments can implement a telescopic representation of a graph in a similar manner as described herein with respect to FIGS. 15-16C.

In some example embodiments, one or more of the operations of the flowcharts described herein may not be performed. Moreover, operations in addition to or in lieu of the operations of the flowcharts described herein may be performed. Further, in some example embodiments, one or more of the operations of the flowcharts described herein may be performed out of order, in an alternate sequence, or partially (or completely) concurrently with each other or with other operations.

The embodiments described herein and/or any further systems, sub-systems, devices and/or components disclosed herein may be implemented in hardware (e.g., hardware logic/electrical circuitry), or any combination of hardware with software (computer program code configured to be executed in one or more processors or processing devices) and/or firmware.

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described example embodiments, but should be defined only in accordance with the following claims and their equivalents.

What is claimed is:

1. A security system of a network-based computing system, comprising:
a processor; and
a memory comprising program code comprising:
a graph generator that:
generates a graph representative of resources in the network-based computing system, the graph comprising a first node representing a first resource, a second node representing a second resource, and an edge between the first and second nodes representing an attack path between the first and second nodes;
a graph reducer that:
determines a level of structural similarity between the first node and the second node satisfies a structural similarity criterion, and
groups the first node and the second node together in a grouped node, resulting in a modified graph; and
an attack path identifier that:
identifies a security vulnerability of the network-based computing system based on the modified graph, and
mitigates the security vulnerability.

2. The system of claim 1, wherein the graph reducer further:
identifies a first edge of the first node having a third node as a target;
identifies a second edge of the second node having the third node as a target; and
groups the first and second edges as a grouped edge.

3. The system of claim 2, wherein:
the graph reducer further:
determines a level of structural similarity between the third node and a fourth node, and
groups the third and fourth nodes as a grouped target; and
the attack path identifier further:
mitigates the security vulnerability with respect to the grouped target.

4. The system of claim 1, wherein to identify the security vulnerability, the graph reducer:
identifies a key accessible to the grouped node; and
determines a number of nodes of the grouped node satisfies a vulnerability criterion.

5. The system of claim 1, wherein to determine the level of structural similarity between the first node and the second node, the graph reducer:
generates a first sparse vector based on a property and an edge of the first node;
generates a second sparse vector based on a property and an edge of the second node; and
determines a distance between the first sparse vector and the second sparse vector satisfies the structural similarity criterion.

6. The system of claim 1, wherein the graph reducer further:
determines a level of structural similarity between the first node and a third node fails to satisfy the structural similarity criterion;
determines a cardinality of the modified graph fails to satisfy a cardinality criterion;
adjusts the structural similarity criterion, resulting in a modified structural similarity criterion;
determines the level of structural similarity between the first node and the third node satisfies the modified structural similarity criterion;
groups the first node, the second node, and the third node in the grouped node; and
determines the cardinality of the modified graph satisfies the cardinality criterion.

7. The system of claim 6, wherein to adjust the structural similarity criterion, the graph reducer:
sets a similarity threshold indicative of nodes that share a type but do not share a property.

8. The system of claim 1, wherein the attack path identifier further:
causes an indication of the security vulnerability to be presented in a user interface of a computing device, the indication indicating an entry point of the security vulnerability.

9. A method for mitigating security vulnerabilities in a network-based computing system, the method comprising:
generating a graph representative of resources in the network-based computing system, the graph comprising nodes representative of the resources and edges between nodes representing respective attack paths between respective nodes;
determining a level of structural similarity between a first node and a second node of the nodes satisfies a structural similarity criterion;
subsequent to determining the level of structural similarity between the first node and the second node satisfies the structural similarity criterion, grouping the first node and the second node together in a grouped node, resulting in a modified graph;
identifying a security vulnerability of the network-based computing system based on the modified graph; and
causing mitigation of the security vulnerability.

10. The method of claim 9, further comprising:
identifying a first edge of the first node having a third node as a target;
identifying a second edge of the second node having the third node as a target; and
grouping the first and second edges as a grouped edge.

11. The method of claim 10, further comprising:
determining a level of structural similarity between the third node and a fourth node;
grouping the third and fourth nodes as a grouped target; and
mitigating the security vulnerability with respect to the grouped target.

12. The method of claim 9, wherein said identifying the security vulnerability comprises:
identifying a key accessible to the grouped node; and
determining a number of nodes of the grouped node satisfies a vulnerability criterion.

13. The method of claim 9, wherein said determining the level of structural similarity between the first node and the second node comprises:
generating a first sparse vector based on a property and an edge of the first node;
generating a second sparse vector based on a property and an edge of the second node; and
determining a distance between the first sparse vector and the second sparse vector satisfies the structural similarity criterion.

14. The method of claim 9, further comprising:
determining a level of structural similarity between the first node and a third node fails to satisfy the structural similarity criterion;
determining a cardinality of the modified graph fails to satisfy a cardinality criterion;
adjusting the structural similarity criterion, resulting in a modified structural similarity criterion;
determining the level of structural similarity between the first node and the third node satisfies the modified structural similarity criterion;
grouping the first node, the second node, and the third node in the grouped node; and
determining the cardinality of the modified graph satisfies the cardinality criterion.

15. The method of claim 14, wherein said adjusting the structural similarity criterion comprises:
setting a similarity threshold indicative of nodes that share a type but do not share a property.

16. The method of claim 9, further comprising:
causing an indication of the security vulnerability to be presented in a user interface of a computing device, the indication indicating an entry point of the security vulnerability.

17. A computer-readable storage medium encoded with program instructions structured to cause a processor circuit to perform a method comprising:
generating a graph representative of resources in the network-based computing system, the graph comprising nodes representative of the resources and edges between nodes representing respective attack paths between respective nodes;
determining a level of structural similarity between a first node and a second node of the nodes satisfies a structural similarity criterion;
identifying a first edge of the first node having a third node as a target;
identifying a second edge of the second node having the third node as a target;
grouping the first and second edges as a grouped edge, resulting in a modified graph;
identifying a security vulnerability of the network-based computing system based on the modified graph; and
causing a mitigation step to be performed with respect to the security vulnerability.

18. The computer-readable storage medium of claim 17, wherein the method further comprises:
determining a level of structural similarity between the third node and a fourth node;
grouping the third and fourth nodes as a grouped target; and
causing the mitigation step to be performed with respect to the grouped target.

19. The computer-readable storage medium of claim 17, wherein said identifying the security vulnerability comprises:
determining a number of nodes associated with the grouped edge satisfies a vulnerability criterion.

20. The computer-readable storage medium of claim 17, wherein the method further comprises:
determining a level of structural similarity between the first node and a fourth node fails to satisfy the structural similarity criterion;
determining a cardinality of the modified graph fails to satisfy a cardinality criterion;
adjusting the structural similarity criterion, resulting in a modified structural similarity criterion;
determining the level of structural similarity between the first node and the fourth node satisfies the modified structural similarity criterion;
grouping the first node, the second node, and the fourth node in the grouped node; and
determining the cardinality of the modified graph satisfies the cardinality criterion.
